(19) United States
(12) Patent Application Publication
(10) Pub. No.: US 2025/0111276 A1
(43) Pub. Date: Apr. 3, 2025

(54) AUTONOMOUS VEHICLE ENVIRONMENTAL PERCEPTION SOFTWARE MANAGEMENT

(71) Applicant: LeddarTech Inc., Québec (CA)

(72) Inventors: Pierre Olivier, Saint-Rédempteur (CA); Pierre Merriaux, Québec (CA)

(21) Appl. No.: 18/833,099

(22) PCT Filed: Jan. 25, 2023
(86) PCT No.: PCT/CA2023/050087

§ 371 Date: Jul. 25, 2024

Related U.S. Application Data
(60) Provisional application No. 63/303,363, filed on Jan. 26, 2022.

(51) Int. Cl. G06N 20/00

(52) U.S. Cl. CPC G06N 20/00

(57) ABSTRACT

A method of operating a computer to build a customized training dataset for training an artificial intelligence (AI) platform, comprising: a) obtaining (i) specifications of training data for training the AI platform and (ii) data indicative of a proposed usage of the training data; b) consulting a database of training datasets, each associated with use rights, to identify a candidate set of training datasets matching the specifications; and c) authorizing release of a subset of the training datasets in the candidate set of training datasets based on the data indicative of the proposed usage of the AI training data and the use rights associated with the training data sets in the candidate set of training datasets.

### CROSS-REFERENCE TO RELATED APPLICATION

This application claims the benefit of U.S. Provisional Patent Application No. 63/303,363 filed on Jan. 26, 2022, hereby incorporated by reference herein.

### FIELD

The present disclosure relates to the management of data components used to train Artificial Intelligence (AI) platforms for use in environmental perception systems, such as to adapt such AI platforms for a range of different applications.

### BACKGROUND

The automotive industry is amid a disruptive change highlighted by the entry of autonomous vehicles (AVs) as well as electrification and ride hailing. While autonomous driving has made considerable strides in the past few years, current solutions are still not safe enough nor are they sufficiently reliable for commercial deployment, except in the most limited scenarios.

To successfully navigate typical driving scenarios, A Vs are equipped with sensing modules that enable them to identify features of the environment while driving. However, the ability to detect a dynamic driving environment surrounding a car, such as other vehicles, pedestrians and small obstacles on the road, while maintaining the car's affordability, is a daunting task. The variety of driving environments also presents its own challenges in accurate autonomous vehicle environmental perception.

The industry has thus turned to Artificial Intelligence (AI) in an effort to improve speed and accuracy of environmental perception. However, it has become increasingly evident that optimal training of an AI platform over a broad range of driving scenarios can result only when a vast quantity of data originating from a large number of different sources is used. This brings about challenges in terms of managing, controlling and distributing the data for both training and using AI platforms, particularly in the context of environmental perception for vehicle navigation, whether terrestrial, marine or airborne.

### SUMMARY

This Summary is provided to introduce a selection of concepts in a simplified form that are further described below in the Detailed Description. This Summary is not intended to identify essential aspects of the claimed subject matter.

Broadly stated, in some embodiments, the present disclosure relates to a method of operating a computer to build a customized training dataset for training an artificial intelligence (AI) platform, comprising: obtaining (i) specifications of training data for training the AI platform and (ii) data indicative of a proposed usage of the training data; consulting a database of training datasets, each associated with use rights, to identify a candidate set of training datasets matching the specifications; and authorizing release of a subset of the training datasets in the candidate set of training datasets based on the data indicative of the proposed usage of the AI training data and the use rights associated with the training data sets in the candidate set of training datasets.

In other embodiments, the present disclosure relates to a non-transitory computer-readable storage medium storing instructions which, when executed by a processing entity of a computing device, causes the computing device to carry out a method build a customized training dataset for training an artificial intelligence (AI) platform, the method comprising: obtaining (i) specifications of training data for training the AI platform and (ii) data indicative of a proposed usage of the training data; consulting a database of training datasets, each associated with use rights, to identify a candidate set of training datasets matching the specifications; and authorizing release of a subset of the training datasets in the candidate set of training datasets based on the data indicative of the proposed usage of the AI training data and the use rights associated with the training data sets in the candidate set of training datasets

In still other embodiments, the present disclosure relates to a non-transitory computer-readable storage medium comprising instructions which, when executed by a computer, cause the computer to carry out a method that comprises: receiving media units from a user; creating training data units based on groups of the media units, each training data unit comprising a plurality of data blocks, wherein the plurality of data blocks for a given training data unit includes: (i) a first data block containing media content from a respective one of the groups of media units; (ii) a second data block indicative of use rights for the given training data unit; (iii) a third data block indicative of media metadata corresponding to the media content in the first data block; and (iv) a fourth data block indicative of a unique user identifier for the given training data unit; and storing the training data units in a non-transitory storage medium or outputting the training data units over a data network.

In yet other embodiments, the present disclosure relates to a method of operating a computer to build a customized training dataset for training an artificial intelligence (AI) platform, comprising: receiving media units from a user; creating training data units based on groups of the media units, each training data unit comprising a plurality of data blocks, wherein the plurality of data blocks for a given training data unit includes: (i) a first data block containing media content from a respective one of the groups of media units; (ii) a second data block indicative of use rights for the given training data unit; (iii) a third data block indicative of media metadata corresponding to the media content in the first data block; and (iv) a fourth data block indicative of a unique user identifier for the given training data unit; and storing the training data units in a non-transitory storage medium or outputting the training data units over a data network.

Features of exemplary embodiments which are described in this disclosure and are not mutually exclusive can be combined with one another. Elements of one embodiment can be utilized in the other embodiments without further mention. Also, not all elements described in association with a particular embodiment need to be present in all implementations or realizations of that embodiment. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of specific exemplary embodiments is provided herein below with reference to the accompanying drawings in which:

FIG. 1 is a block diagram of a computer-based infrastructure to generate customized, application-specific data sets for training an AI platform, in accordance with a non-limiting embodiment.

FIG. 2 is a more detailed block diagram of a user workstation and a management server, showing the main functional blocks of the workstation and the main functional blocks of the server, in accordance with a non-limiting embodiment.

FIGS. 3A-C are Graphical User Interface (GUI) flows illustrating the different GUI controls allowing a user at the workstation that implements the GUI to specify parameters of an application-specific training data set, in accordance with a non-limiting embodiment.

FIG. 4 is a diagram illustrating the format of a training data unit, in accordance with a non-limiting embodiment.

FIG. 5 is a table showing conceptually the information conveyed in the user rights block of the training data unit, in accordance with a non-limiting embodiment.

FIG. 6 is a table showing conceptually the information conveyed in the metadata block of the training data unit, in accordance with a non-limiting embodiment.

FIG. 7 is a block diagram of an exemplary AI platform, in accordance with a non-limiting embodiment.

FIG. 8 is a semantic environment representation output by the AI platform, in accordance with a non-limiting embodiment.

FIG. 9 is a flowchart of a process to extract an application-specific training data set from a training data collection, in accordance with a non-limiting embodiment.

FIG. 10 is the flowchart of FIG. 9, according to a variant.

FIG. 11 shows the block diagram of FIG. 2, according to a variant.

FIG. 12 shows the block diagram of FIG. 11, according to a variant.

FIG. 13 is a flowchart of a process for uploading media to the management server for use in generating training data units, in accordance with a non-limiting embodiment.

FIG. 14 is a flowchart of a process for generating a training data package from an application-specific training data set, in accordance with a non-limiting embodiment.

FIG. 15 is a block diagram of the system shown in FIG. 2, according to a variant.

FIG. 16 is a block diagram of the system shown in FIG. 15, according to a variant.

FIG. 17 is a block diagram of the system shown in FIG. 16, according to yet another variant.

FIG. 18 is a flowchart of a process for generating a training data package, in accordance with a non-limiting embodiment.

FIG. 19 is a block diagram similar to the block diagram of FIG. 16, according to yet another variant.

FIG. 20 illustrates the data structure of a learned parameters package, in accordance with a non-limiting embodiment.

FIG. 21 is a flowchart is a process for generating a learned parameters package, in accordance with a non-limiting embodiment.

FIGS. 22a, 22b, 22c and 22d are GUI screens illustrating user controls to select the parameters of the learned parameters package, in accordance with a non-limiting embodiment.

FIG. 23 is a block diagram of a system for performing updates of learned parameters of an AI platform, in accordance with a non-limiting embodiment.

FIGS. 24a, 24b and 24c are GUI screens illustrating selectable user options to customize the operation of the environmental perception system, in accordance with a non-limiting embodiment.

FIG. 25 is a flowchart of a process for updating the learned parameters of an AI platform, in accordance with a non-limiting embodiment.

FIG. 26 is a mapping between the information obtained from a user of the AI platform and a training data unit, in accordance with a non-limiting embodiment.

FIG. 27 is a block diagram of a computing system that may be used to implement various aspects of a management server.

FIG. 28 conceptually illustrates a training data package as a data structure comprised of various fields some of which represent training data units as shown in FIG. 4, in accordance with a non-limiting embodiment.

The drawings illustrate examples and are not intended to be limiting.

### DETAILED DESCRIPTION

The present technology is explained in greater detail below. This description is not intended to be a detailed catalog of all the different ways in which the technology may be implemented, or all the features that may be added to the instant technology. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art considering the instant disclosure which variations and additions do not depart from the present technology. Hence, the following description is intended to illustrate some embodiments of the technology, and not to exhaustively specify all permutations, combinations, and variations thereof.

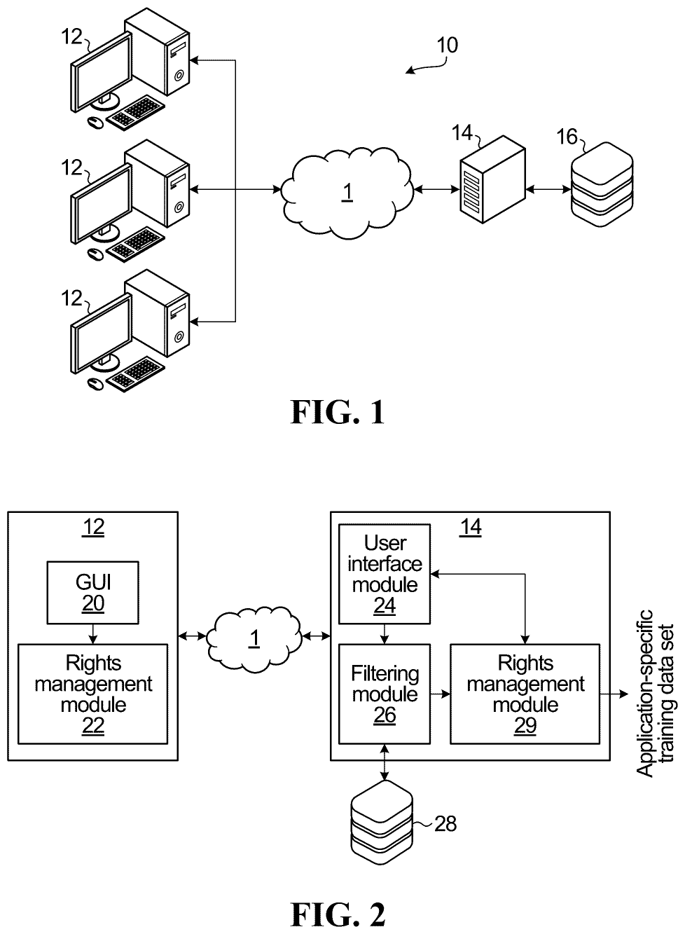

FIG. 1 is a block diagram of a system allowing a user to build a customized training data set in order to train an AI platform (to be discussed in the following paragraph) to perform environmental perception. The system 10 has different building blocks and functional elements which are implemented in hardware or software to perform individual tasks. The system 10 includes a series of workstations 12 that communicate over a data network 1 with a training data set collection management server 14. In turn, the management server 14 manages access to a training data set collection stored in a database 16. Based on specifications provided at a workstation 12 defining the desired performance or characteristics of an environmental perception system, the management server 14 will build a customized collection of training data for the AI platform in order to train the AI platform to achieve such environmental perception performance or characteristics.

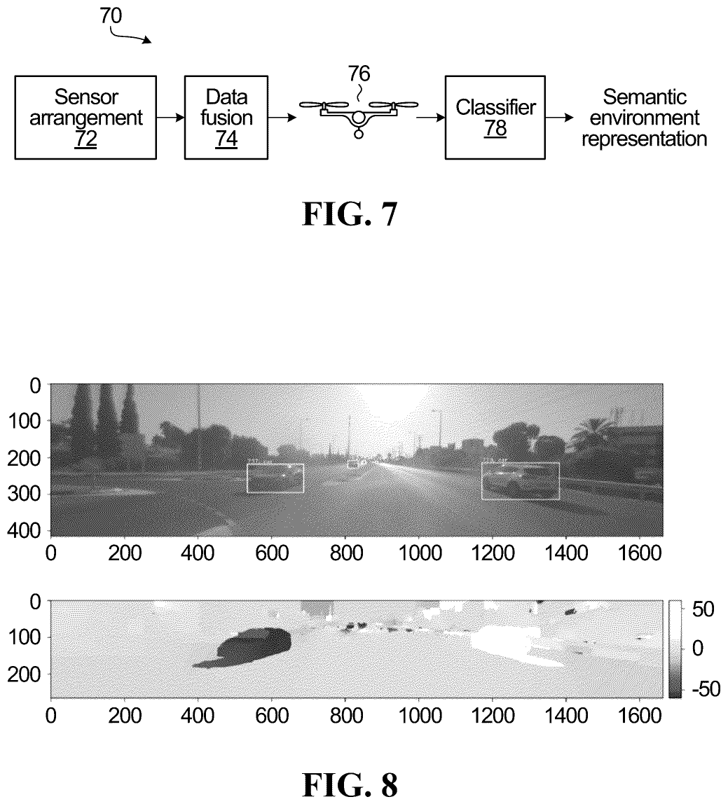

The main components of an exemplary AI platform that can be trained with the customized training data set are shown at FIG. 7, it being understood that a range of different AI platform architectures can be used without departing from the spirit of the invention. More specifically, the AI platform 70 includes a sensor arrangement 72 which outputs an electronic representation of an environment. The sensor arrangement 72 operates based on a single sensor modality or multiple sensor modalities. For example, the sensor arrangement 72 can use one or more image sensors to output high-resolution camera images. If the sensor arrangement 72 uses multiple sensor modalities, it can use, in addition to the image sensor a LIDAR sensor, a RADAR sensor and/or an ultrasonic sensor that output a depth map of the environment. The outputs of the different sensors are combined by the raw-data fusion functional block 74 which produces a high-resolution 3D map of the environment. Typically, the 3D map represents the environment with pixels that provide RGB color information. In addition, distance values are associated with each pixel, indicating the distance from a point of reference to an object in the environment, a part or segment of which is visually represented by the pixel. Typically, the point of reference would be the sensor arrangement 72.

The high-resolution 3D map is then input into a trained neural network 76, which can be a convolutional neural network to perform detection of objects that the neural network 76 has been trained to recognize in the 3D map. The output of the neural network 76 is then fed to a classifier 78 that performs classification of the detected objects. The classifier 78 outputs a semantic representation of the environment depicted by the 3D map. For instance, that semantic representation may include an identification in the 3D map of objects of interest, a timestamp and identification of the velocity (speed+direction of motion) of the detected objects. FIG. 8 is an example of a semantic representation in which the top image shows the detected objects with bounding boxes and the lower image is a velocity map showing the velocity of the detected objects.

For further details about a suitable non-limiting AI platform which may be used as the AI platform 70, reference should be made to WO2021092702A1, hereby incorporated by reference herein.

In an autonomous or semi-autonomous vehicle application, the semantic environment representation would typically be input into a driving policy module that would compute a vehicle path according to the 3D representation, which in turn would be used by a control module to direct the vehicle according to the computed path. In addition to the 3D representation, the driving policy module may also use additional inputs to compute the vehicle path, such as current position generated by a GPS module or other, map data, etc.

With reference to FIG. 2 which is a more detailed block diagram of a workstation 12 and of the management server 14, the workstation 12 includes a Graphical User Interface (GUI) functional block 20, which operates to implement a GUI allowing the user to input the specifications of the environmental perception system. In a specific example of implementation, the GUI can be implemented via a web browser, under control of the management server 14. Accordingly, in this form of implementation, the workstation 12 establishes a communication session with the management server 14 via a data network 1 (such as the Internet, or a local area network) and receives scripts or other commands from the management server 14 to implement the GUI, accept user inputs at the GUI and receive user messages via the GUI.

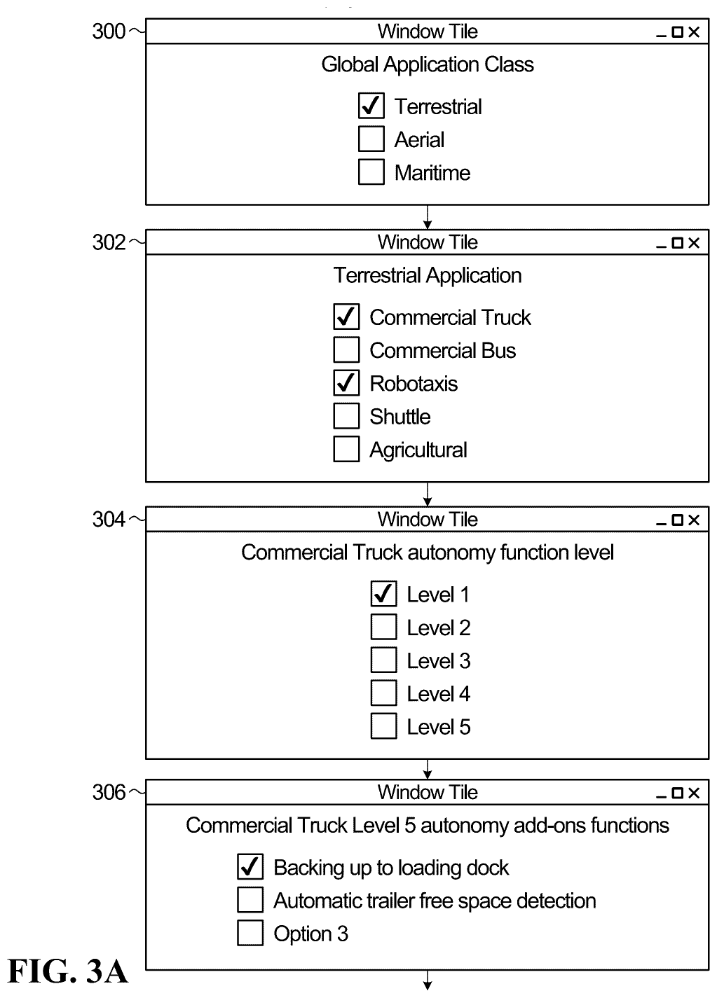

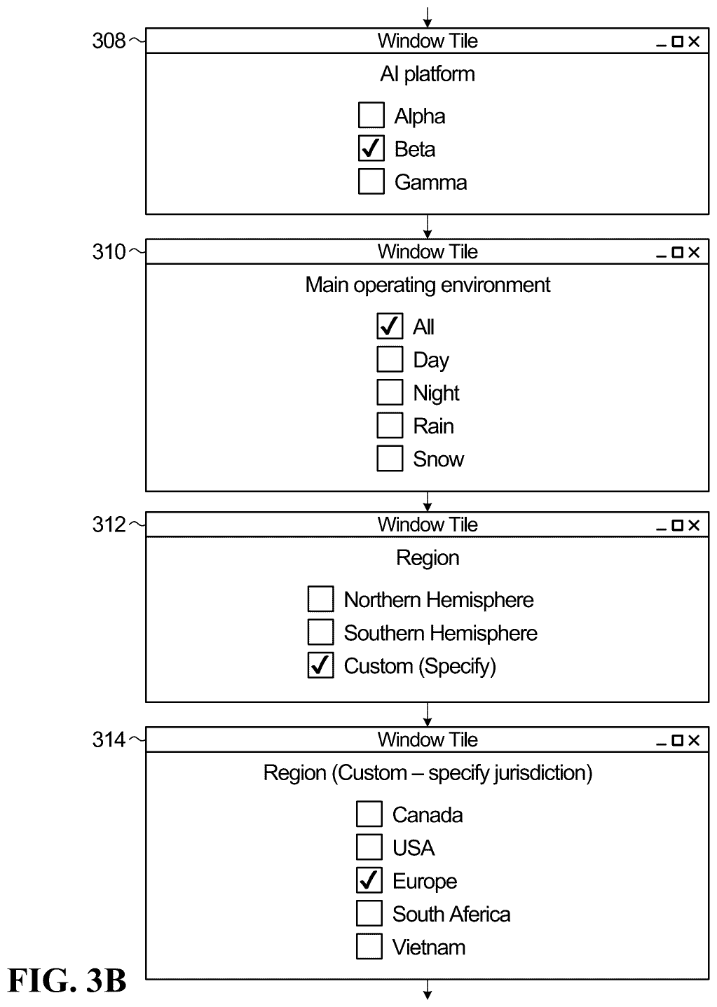

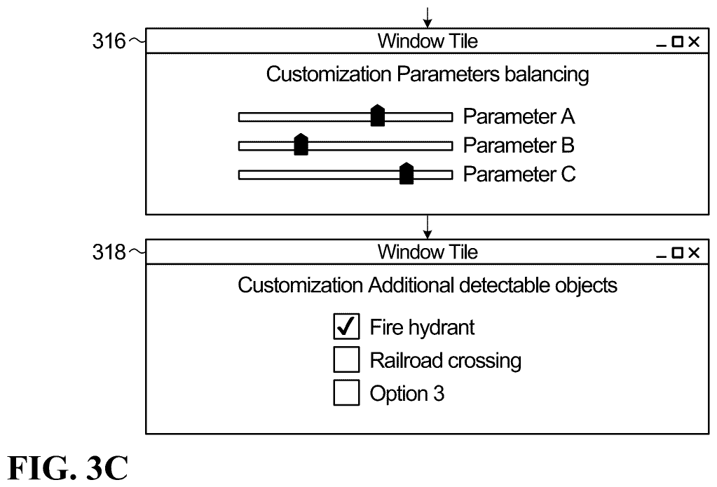

An example of a workflow via the GUI to enable the user to define the specifications of the desired environmental perception system is shown at FIGS. 3A to 3C, it being understood that such workflow is exemplary and that many variations are possible.

The workflow is defined by a series of GUI pages which provide the user with controls where the user inputs information about the environmental perception system application. User inputs at one GUI page condition the subsequent GUI pages such that the user is logically directed toward valid input options.

As an initial GUI page, the user sees page 300 where the user can indicate via a series of checkboxes or other input mechanism the Global Application Class of the environmental perception system. In this example, the Global Application Class is defined in terms of terrestrial applications (terrestrial vehicles), aerial applications (drones or other) and maritime applications (maritime vessels), but other definitions or categories are possible.

When the user chooses the terrestrial application, the GUI page 302 is displayed requesting input on the specific terrestrial application. Examples of terrestrial applications include without being limited to commercial truck, commercial bus, robotaxi, shuttle and agricultural vehicle. In the example shown, the user has selected “commercial truck”. After the selection is made, the GUI page 304 is displayed, where the user can specify the degree of autonomy level, it being understood that the intensity of AI training may be different for higher levels of autonomy than for lower levels where the human driver is always responsible for controlling the vehicle.

At GUI page 306 the user can specify add-on functions, allowing automating certain vehicle maneuvers. Again, the selections available at the page 306 depend on previous choices made by the user. That is to say, the system is configured such as the options presented are valid options for the intended application. In this example, “backing up to a loading dock” has been selected. This selection would require the environmental perception system to detect loading docks as objects in the 3D map such that the driving policy module can compute the backing-up maneuver. Accordingly, the training data need to be customized for this add-on function by providing loading dock images such that the AI platform can reliably recognize a loading dock.

Another option in the context of the commercial truck application is automatic trailer free-space detection, as described in US publication US20200062273A1, hereby incorporated by reference herein. In this case, the environmental perception system is trained to detect the presence of a trailer attached to the truck and the size of the trailer such that the free space parameter of the vehicle can be adjusted during autonomous driving.

At the next GUI page 308, the user specifies the AI platform that is to be trained. It should be appreciated that the training data depends on the capabilities and characteristics of the AI platform. For example, an AI platform that uses only cameras to sense the environment would only need camera images for training, while an AI platform using sensors of different modalities may need training data generated by a range of sensors. While not shown in the drawings, the selection list of the GUI page 308 is dynamically updated as new AI platforms become available on the market and it is desirable to be able to generate training data sets for those platforms. For instance, the management server 14 maintains a database of AI platforms, associating with each entry the hardware and/or software specifications of the platform that influence the choice of training data. As this list of AI platforms is updated in the database, the available selections at the GUI page 308 are updated as well. More specifically, the AI platform can be characterized based on the following parameters, which can be specified at the GUI page 308 by the user:
a. Type (modality) of sensors, such as camera, LIDAR, RADAR and acoustic sensor, among others.
b. Number of sensors of each modality,
c. The locations of the sensors of each modality on the vehicle,
d. The computing hardware capabilities and characteristics, such as distributed, centralized, etc.

The GUI page 310 allows the user to specify the main operating environment of the AI platform, which again would condition the training data to be used to adapt the environmental perception performance to this operating environment. Examples of operating environment include day, night, rain, snow, etc. For instance, for a commercial truck that is intended exclusively for night operations, the training data should be chosen accordingly and would be different from the training data in the case of a daytime exclusive operation.

GUI page 312 allows the user to select the region in which the AI platform will be operated. The region selection can influence the choice of training data in terms of media content, but is also a useful input in terms of regulatory compliance. For example, data privacy laws may not allow training data collected in a certain region to be used for training an AI platform operated in a different region. Accordingly, the selection made at the GUI page 312, can be used to identify in the training data collection only the training data that is authorized for the intended use, hence ensuring regulatory compliance. The GUI page 312 provides a general region input which can be customized at the country level at the GUI page 314, it being understood that a further level of granularity can be provided, at the state or city level, if desired. Another non-limiting example level of granularity may be based on separating locations/countries between those where vehicles drive on the right side of the road versus those where vehicles drive on the left hand side of the road.

The GUI page 316 at FIG. 3C allows the operator to specify further parameters of the training data. Also, a GUI page such as the one shown at page 318 can be provided to include in the training data some additional objects that may not be included in the set derived from the previous specifications. For example, the AI platform to be trained may be operated in an environment where railroad crossings need to be detected with high reliability, hence the need to specify that object.

Referring back to FIG. 2, in addition to the GUI functionality 20, the workstation 12 also implements a rights management agent 22, which is software program designed to interact with the management server 14 to respond to a licensing challenge from the management server 14, in order to establish that the workstation 12 is properly licensed to interface with the management server 14 to build customized training data sets.

The management server 14 has several functional blocks or modules which are implemented in software, hardware or a combination of software and hardware. More specifically, the management server 14 includes a user interface module 24, which is the software component that implements via the web browser, the GUI interface 20 described earlier. The user interface module 24 establishes a communication session with the workstation 12 and dynamically updates the GUI pages as the user provides the specifications for the environmental perception system. The GUI hierarchy, options and specifications input flow can be stored in the machine-readable storage of the management server 14 and referenced by the user interface module 24 to update the GUI pages as the user makes the user inputs, such that the options selectable via the GUI are always valid.

In addition to managing the GUI pages, the user interface module 24 collects the user inputs and builds a query that will allow extracting, from the training data collection, the customized training data set matching the specifications of the query.

The management server 14 also includes a filtering module 26 which is the interface with the database 28 storing the training data collection. The user interface module 24 thus transfers the query to the filtering module 26 which runs the query to extract from the training data collection in the database 28 the training data set that matches the query. The extraction operation will be described in greater detail later.

The management server 14 further includes a rights management module 29 which manages the usage of the training data in the training data collection to ensure the usage is compliant with rights and regulations, as it will be described in greater detail later.

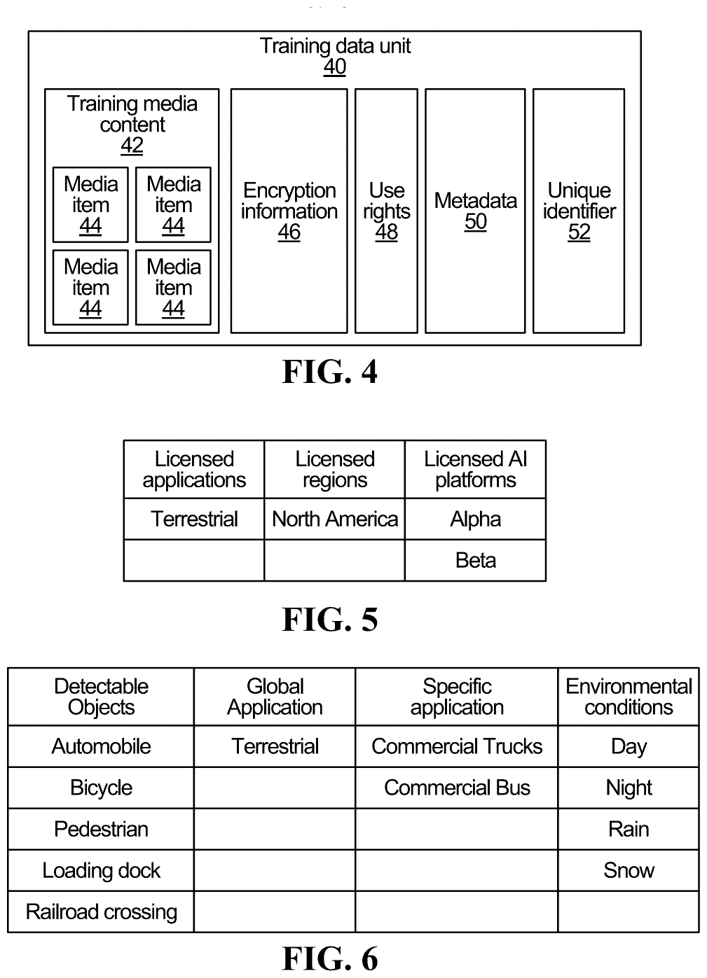

With reference to FIG. 4, the training data is stored in the database 28 in the form of discrete training data units 40. Each training data unit 40 is organized into data blocks (or fields) as follows:
a. A training media content block 42 contains media items containing the training media used for the actual training of an AI platform such as the AI platform 70. Such training media can be still camera images with annotations to identify objects of interest in the images. Alternatively, the training media can include continuous images, such as video with or without audio information. Alternatively or in addition, the training media includes environment representations, such as depth maps, generated by other sensors, such as LIDAR, RADAR and ultrasonic sensors among others. The size of the training media content block 42 in a training data unit 40 can vary. As shown in FIG. 4, the training media content block 42 is a block including several media items 44. A media item 44 can be a single camera or video frame or a depth map frame. The number of media items 44 per training media content block 42 can vary. Note that in most applications, the media items 44 will be of the same sensor modality, such as all camera frames, all LIDAR depth maps, etc. However, it is possible to bundle in a single training data unit 40 media items 44 of different sensor modalities, such as 3D map frames obtained by fusing the output of a camera sensor and the output of a LIDAR, RADAR, or ultrasonic sensor.
b. Encryption information block 46. The encryption information block 46 stores an encryption key identifier that would allow the management server 14 to enable decryption of information in the training data unit 40. That process will be described later.
c. Use rights information block 48, which defines under what circumstances the training media in the training media content block 42 can be used for performing AI platform training. An example of use rights is shown in the table of FIG. 5. In this example, there are three categories of permissions or rights, namely applications for the AI platform, regions in which the AI platform trained with the training data can be used and specific AI platforms that can be trained with the training data. The example shows that the training data can be used for terrestrial applications but cannot be used for aerial or maritime applications, as aerial and maritime are not listed. It is to be understood that the licensed applications can be defined with finer granularity to distinguish between a range of terrestrial, maritime or aerial uses. Note that the level of granularity with which the licensed applications are defined in the use rights information block 48 should match the level of granularity at which the applications are input via the GUI at the workstation 12, such that a check for compliance can be made by comparing the two. The example of FIG. 5 further specifies a licensed region, which in this case is North America. Accordingly, the training data cannot be used for AI platforms that will operate outside North America. The licensed region can be defined with finer granularity, for example on a per country basis. The use rights information block 48 further specifies the identification of the AI platform(s) that can be trained with this training data. In the example, the AI platform that is licensed is generically defined but it is possible to use narrower definitions, for example by providing each AI platform with a serial number and listing in the licensed AI platform field all the authorized platform. This feature is useful in instances where training data is owned by a third party, and it should be used for training only AI platforms that belong to the third party. In such case the licensed AI platforms field will list only the third-party AI platforms, such that no other AI platforms can use such third-party specific data. It will be noted that additional use rights or permissions can be specified, such as date of expiration. Another example is to specify a particular environment in the context of a certain application, such as a dataset of military vehicles that can only be used for a specific country's Department of Defense. Another example would be the excision of certain information in the training media, such that the training media is ‘clean’ from objectionable or restricted data. Restricted data could include license plate information or human faces. Yet another example is to specify road type or condition, such as paved road, unpaved road, highway or street, snow covered road, road wet from rain, etc.
d. Metadata block 50, which characterizes the actual media content for AI training purposes to allow training data filtering based on the query. The metadata block 50 characterizes the media with parameters similar to the environmental perception specification at the GUI shown at FIG. 3A to 3C. For instance, as shown at FIG. 6 in an exemplary table, the characteristics of the training data are based on application scope which may include a list of objects that are depicted in the media items 44, the suitability of the media items 44 in terms of global application (terrestrial), specific application (commercial trucks and buses) as well as environmental conditions. The list of objects can be generated as a result of human observation of the media items 44, such as an individual looking at an image and identifying objects that appear in the image and making the annotations. Alternatively, the list of objects can be generated by machine processing of an image, such as processing an image with an AI system, which outputs the list of objects and annotations. Optionally, that machine-generated list can be reviewed by a human operator for accuracy. Also, the media content and the list of objects and annotations can be generated mostly synthetically, that is via a simulation system which creates a virtual environment with virtual objects and renders the environment and objects as a series of photorealistic images with object lists and annotations that can be used for the AI training in combination with traditional training data material. It is also possible to specify in the metadata block 50 associated with certain training data (in the training media content block 42), whether the training data is synthetically generated, or generated as a result of imaging a real-world environment. Such distinction can be useful in instances where training standards are provided that specify a minimal amount of training data obtained from imaging a real-world environment. For example, the specifications may stipulate that at least X % of the training data must come from real-word imaging and at most (100-X) % can be synthetically generated, where X can be 10%, 25%, 50%, 75% or any other percentage.
e. Unique identifier block 52 for this training data unit 40, allowing this training data unit 40 to be distinguished from other training data units in the collection stored in the database 28. Unique identifier block 52 is optional, e.g., if there is some other way of uniquely identifying the training data unit 40. Additionally, from a traceability perspective, the training data units can be encoded through blockchain algorithms to ensure they are not altered and their origin or source is well-defined.

The creation of training data units (such as training data unit 40, also referred to as a training datasets) can thus be achieved by executing computer-readable instructions stored on a non-transitory computer-readable storage medium. When executed by a computer, such instructions cause the computer to carry out a method that comprises receiving media units from a user; creating training data units based on groups of the media units, each training data unit comprising a plurality of data blocks and storing the training data units in a non-transitory storage medium or outputting the training data units over a data network. The plurality of data blocks for a given training data unit includes a first data block containing media content from a respective one of the groups of media units; a second data block indicative of use rights for the given training data unit; and a third data block indicative of media metadata corresponding to the media content in the first data block.

In some embodiments, the plurality of data blocks for the given training data unit further incudes a fourth data block indicative of a unique user identifier for the given training data unit.

In some embodiments, the method further comprises grouping the media units into said groups of media units.

In some embodiments, the grouping comprises grouping the media units based on objects depicted in the media units.

In some embodiments, the method further comprises carrying out image processing to identify objects depicted in the media units and wherein the grouping is carried out so as to group together media units that depict at least some of the same objects.

In some embodiments, the media metadata in the third data block for the given training data unit comprises information related to the objects depicted in the respective group of media units.

In some embodiments, the method further comprises receiving a list of objects depicted in the media units and wherein the grouping is carried out so as to group together media units that depict at least some of the objects in the list.

In some embodiments, the media metadata in the third data block for the given training data unit is indicative of whether the media content of the respective group of media units was derived from real-world imaging or was derived synthetically.

In some embodiments, the method further comprises validating an identity of the user before the receiving.

In some embodiments, the storing includes encrypting at least part of the training data units.

In some embodiments, the encrypting comprises encrypting only the first data block of each of the training data units.

In some embodiments, the encrypting is carried out using an encryption key stored in memory.

In some embodiments, upon being stored, the media unit in the first data block of each of the training data units is decryptable by a decryption key.

In some embodiments, the decryption key and the encryption key are the same.

In some embodiments, the decryption key is uniquely associated with but different from the encryption key.

In some embodiments, the plurality of data blocks further includes fifth data block indicative of how to determine the decryption key.

In some embodiments, the use rights for the given training data unit include an indication of a licensed application scope for the given training data unit.

In some embodiments, the use rights for the given training data unit include an indication of a licensed geographic region for the given training data unit.

In some embodiments, the use rights for the given training data unit include an indication of a licensed AI platform for the given training data unit.

In some embodiments, the method further comprises determining the use rights for the given training data unit and storing the use rights in the second data block for the given training data unit

In some embodiments, the media units comprise 2D camera images, whereas in other embodiments, the media units comprise LiDAR or RADAR data and in still other embodiments, the media units comprise an ultrasonic depth map.

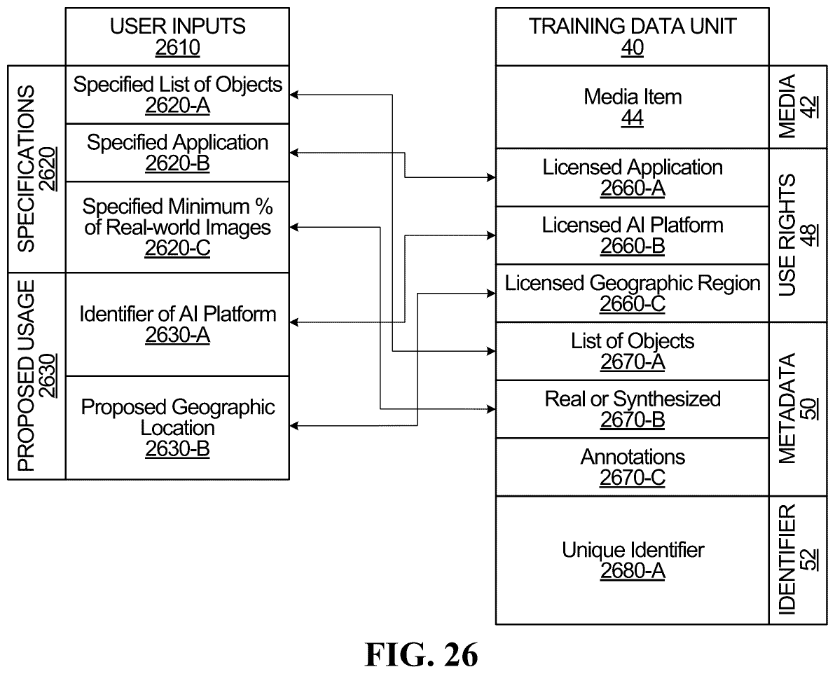

To further help visualize the relationships between the information requested from the user via the GUI (FIGS. 3A-3C) and the information stored in the training data units (FIG. 4), reference is made to FIG. 26 which is a non-limiting illustration as to how user inputs (denoted 2610) are mapped to a training data unit 40. Here, the user inputs received from the user via the GUI may be categorized into specifications 2620 and a proposed usage 2630 each having their own sub-fields, whereas the training data unit 40 has its own organization and sub-fields as discussed above with reference to FIG. 4. Specifically:
a. The specifications 2620 may include:
   i. a specified list of objects sub-field 2620-A, which maps to a list of objects sub-field 2670-A of the metadata block 50 of the training data unit 40;
   ii. a specified application sub-field 2620-B, which maps to a licensed applications sub-field 2660-A of the use rights block 48 of the training data unit 40;
   iii. a specified minimum % of real-world images sub-field 2620-C, which maps to a % of real-world images sub-field 2670-B of the metadata block 50 of the training data unit 40.
b. The proposed usage 2630 may include:
   i. a specified identifier of the AI platform sub-field 2630-A, which maps to a licensed AI platforms sub-field 2660-B of the use rights block 48 of the training data unit 50.
   ii. a proposed geographic location sub-field 2630-B, which maps to licensed geographical locations sub-field 2660-C of the use rights block 48 of the training data unit 50.

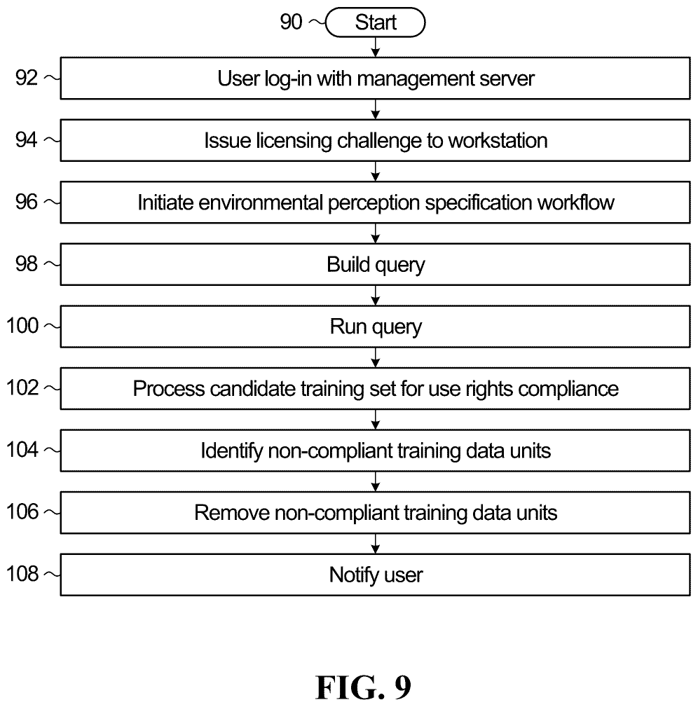

FIG. 9 is a flowchart illustrating steps in an example process for building a customized training data set for an AI platform such as the AI platform 70.

The process starts at 90. At step 92, the user at workstation 12 logs in at the management server 14. At step 94, the management server 14, in particular the rights management module 29, issues, via the data network 1, a licensing challenge to the workstation 12, which is handled by the rights management agent 22. If the rights management agent 22 supplies an adequate response, the management server 14 opens a training data set building session at step 96 and initiates the environmental perception specification workflow, by presenting the user at the workstation 12 with the GUI pages shown at FIGS. 3A to 3C.

At step 98, the user interface module 24 collects the inputs entered by the user via the GUI pages and builds a query accordingly. At step 100, the query is passed to the filtering module 26 that runs the query to extract, from the database 28, the subset of training data units which matches the query. In particular, the filtering module 26 extracts those training data units with a metadata block 50 that matches the query parameters (see also FIG. 26).

At step 100, the filtering module 26 outputs a candidate training set which is processed at step 102 by the rights management module 29 for use rights compliance. In particular, the rights management module 29 will compare the use rights associated with each training data unit in the candidate data set against the parameters supplied by the user (again, see also FIG. 26) to determine if the projected use is compliant. For example, the rights management module 29 will compare the prospective AI platform application with the licensed applications, the prospective use region with the licensed regions and the prospective AI platform with the licensed AI platforms. If any discrepancy is found, the training data unit is removed from the candidate set, leaving only the compliant training data units, as shown at step 106.

The rights management module 29 may then send a message to the user at the workstation 12 to notify the user of the number of training data units that have been excluded from the candidate set for non-compliance with use rights. This indicates to the user if too many training data units are excluded and too few training data units remain to perform adequate training. If the non-compliance can be cured in some way, the rights management module 29 may trigger such process. For example, if additional licensing can be obtained to achieve compliance against payment, the rights management module 29 calculates a fee due and indicates it to the user via the GUI pages. If the user makes the payment, the rights management module 29 will alter, permanently or temporarily, the licensing parameters in the use rights block 48 of the excluded training data units such that they can be put back in the original list.

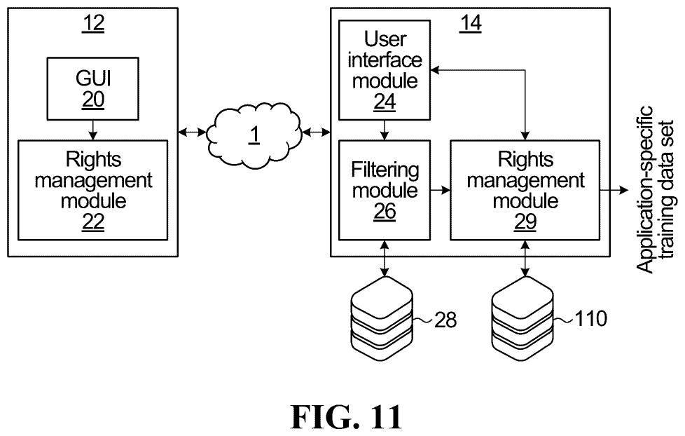

In some embodiments, the training media content block 42 of the training data unit 40 is encrypted. This is done to control the use of the media items 44 in the training media content block 42. Use of the media items 44 in the training media content block 42 is enabled by decrypting the training media content block 42. The encryption/decryption process uses data stored in the encryption information block 46. As indicated previously, the encryption information block 46 stores an encryption key identifier which maps to an encryption key in an encryption key database 110 (see FIG. 11). In order to decrypt the training media content block 42, and allow access to the media items 44 containing training media, access to the appropriately identified encryption key in the encryption key database 110 is necessary and such access is achieved as described below.

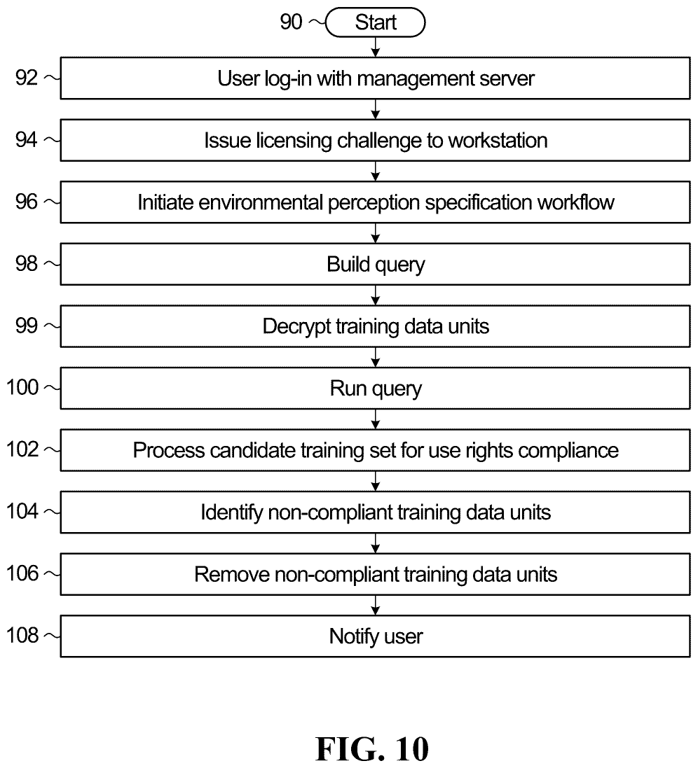

In a first possible implementation option, the training media content block 42 and some of the other information blocks (such as the use rights block 48 and the metadata block 50) are encrypted. In this first implementation option, decryption must be performed so as to access the metadata and the user rights information to determine if a particular training data unit matches the query and can be used for the specified application. The decryption process is illustrated at the flowchart shown in FIG. 10, which is a variant of the flowchart in FIG. 9, showing an additional decryption step 99. The flowchart at FIG. 10 should be read in conjunction with FIG. 11, which is a variant of FIG. 2, illustrating the encryption/decryption functionalities of the management server 14.

Initially, with reference to FIG. 11, the rights management module 29 interfaces with the encryption key database 110 in which are stored encryption/decryption keys mapped to respective key identifiers which populate the encryption information blocks 46 of various respective training data units 40. For the relevant portions of an encrypted training data unit to be decrypted, the decryption key is extracted from the encryption key database 110 and the decryption process is performed. The process is shown in greater detail in the flowchart of FIG. 10, with step 99 showing the additional step of decrypting the relevant portions of the training data unit 40 before running the query. For each such training data unit to be decrypted, the decryption process would require reading the key identifier in the encryption information block 46, extracting the corresponding decryption key from the encryption key database 110 and decrypting the data in the training data unit 40 (e.g., the data in the training data content block 42, the use rights block 48 and the metadata block 50) such that step 100 can determine if the training data unit 40 matches the query parameters.

Prior to releasing the key from the encryption key database 110, the rights management module 29 may determine if the user is allowed to access the training data unit 40 for the purposes of building a training data set. To elaborate, a distinction is being made between use rights for AI platform applications, which is authorizing the use of certain media for training a particular AI platform on the one hand and, on the other hand, allowing a user to use the training data management tools to build a training data set and use the set for training an AI platform. The two are different processes and the user that builds a training data set may require a separate license (build and train license) to use the data management tools and training dataset collection to build a customized training data set and then use the customized training data set for training the AI platform. If such separate license is required, before a decryption key is released from the encryption/decryption key database 110, the rights management module 29 will perform the necessary compliance verification to determine if the user is properly licensed to build a training data set. The compliance verification involves a communication between the rights management module 29 and the rights management agent 22 such as to establish the scope of the license granted to the user and to determine if the scope of the license encompasses the projected use.

A practical example may better illustrate this. Assume Company A wants to develop an AI platform and needs a suitable training data set. Company A hires a commercial service that uses the infrastructure shown in FIG. 11 to build customized training data sets. However, Company A, has its own training data set and wants this customer-owned training data set to be bundled with the training data set of the commercial service. Company A will therefore contribute its own training data set to the database 28 such that it can be integrated into the overall process on the condition that the customer-owned data set not be used for any other projects in which the commercial service is involved. Accordingly, a licensing mechanism would be necessary to ensure that access to the customer-owned training data set is allowed only for work performed for that customer. Accordingly, the licensing rights for the use of the customer-owned training data are set such that access to the training data for the building of a customized training data set is allowed only for customer-related projects and no other projects. The licensing rights are therefore set at the rights management agent 22 in the user workstation and the scope of those rights is established by the rights management module before decrypting the training data unit 40.

In a second possible implementation, only the training media content block 42 of the training data unit 40 is encrypted. In this form of implementation, the use rights information (in the use rights block 48) and the metadata information (in the metadata block 50) are always readable and enable building the customized data training set without the necessity of decryption, while the training media itself remains encrypted.

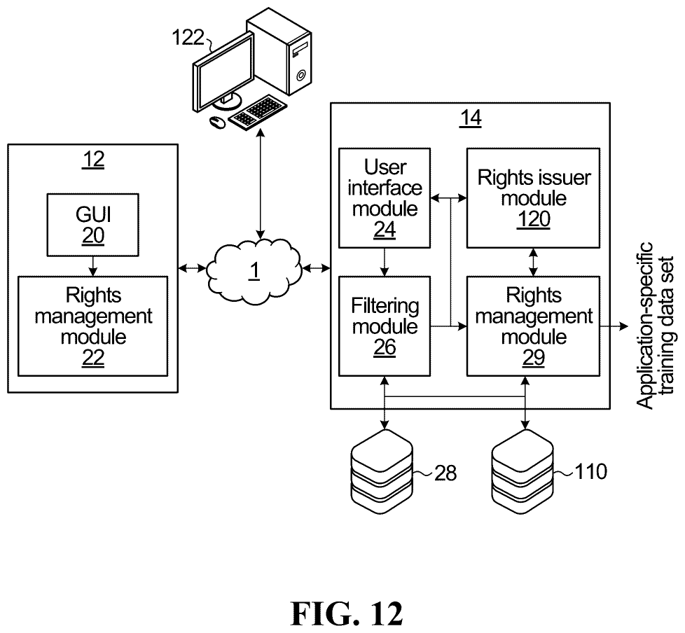

FIG. 12 is a variant of FIG. 11 and illustrates an additional feature, which is the provision of a rights issuer module 120 to enable a third party to contribute to the training data collection while controlling the use of the contributed training data. Reference numeral 122 identifies a third-party workstation at which is loaded third-party training data. The training data can be organized as a series of media items 44, such as annotated camera images, annotated LIDAR, RADAR and ultrasonic depth maps, among others. The third-party workstation 122 sends the training data (i.e., media items 44) to the management server 14 for integration in the training data collection stored at the database 28. The rights issuer module 120 is enabled such as to package the media items 44 into searchable and manageable training data units 40 and also to associate with those training data units 40 use rights that the third-party can control.

Communication between the third-party workstation 122 and the management server 14 is handled via the user interface module 24 that can provide via a web browser or via any other equivalent arrangement a GUI at the third-party workstation 122 to allow a user the workstation 122 to upload the media items 44. The GUI, not shown in the drawings, is configured with controls allowing the user at the workstation 122 to:
a. Group the individual media items 44 logically together, for example, on the basis of depicted objects.
b. Generate the metadata.
c. Generate the use rights, such specify the licensed applications, licensed regions and licensed AI platforms.

Upon entry of the information items 1, 2 and 3, the rights management module 29 will process the uploaded media items 44 and package them into training data blocks 42 and will also create the encryption information block 46, the use rights block 48, the metadata block 50 and the unique identifier block 52 for each training data block 42. The result is a series of created training data units 40 which are then stored in the database 28.

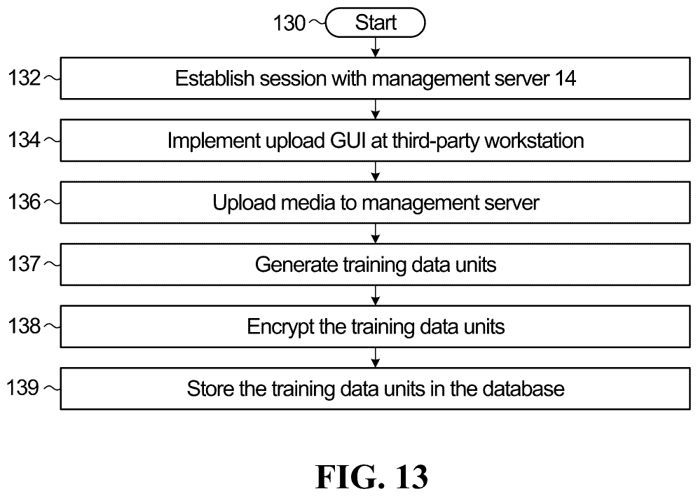

FIG. 13 is a flowchart which illustrates the process of uploading and integrating third-party training data into the training data collection.

The process starts at 130. At step 132, the workstation 122 communicates with the management server 14 and establishes a session, which may require supplying user credentials to validate the user identity at the workstation 122. At step 134, the user interface module 24 implements via a web browser a GUI at the workstation 122 with controls to allow the user of the workstation 122 to upload its media items (which is third-party training data from the perspective of the management server 14). At step 136, the user of the workstation 122 specifies via the GUI the media items 44 to upload, the manner of grouping of such media items 44 into training data units and, for each such training data unit, the corresponding metadata and the use rights. At step 137, the rights management module 29 processes the uploaded information and generates the training data units 40. At step 138, the rights management module 29 may encrypt the training data units 40 (according to one of the aforementioned options, i.e., either only the media items are encrypted or also the metadata and the use rights) and at step 139, the rights management module 29 stores the optionally encrypted training data units 40 in the training data database 28.

Referring back to FIG. 12, the process of building the application-specific training data set generates a collection of training data units 40, which is a subset of the collection of training data units 40 in the database 28. That subset constitutes in itself a digital product which is processed by the rights issuer module 120 of the management server 14 such as to properly package the product (referred to as a “training data package”) and associate to it use rights, thus allowing the owner of that digital product to control how this digital product is being used downstream.

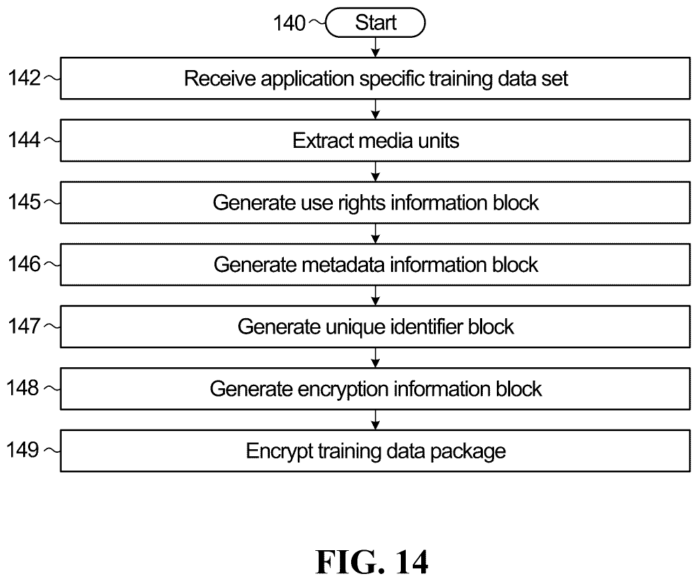

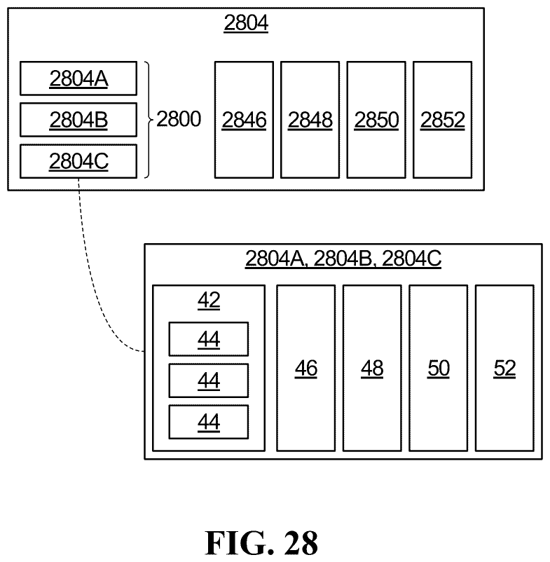

With reference to the flowchart in FIG. 14 and with additional reference to FIG. 28, the process of creating a training data package 2800 as a product in its own right will now be described in greater detail

The process starts at step 140. At step 142, the rights issuer module 120 receives the application-specific training data set 2804 produced by running the query on the database 28. By “receiving” is meant that the rights issuer module 120 has access to the training data units 2804A, 2804B, . . . 2804C that are selected by having run the query. For example, the rights issuer module 120 may be provided with an index in the database 28 to point to the entries in the database 28 corresponding to the selected training data units 2804A, 2804B, . . . 2804C, thus allowing the rights issuer module 120 to fetch sequentially the training data units 2804A, 2804B, . . . 2804C from the database 28 and process them.

At step 144, the rights issuer module 120 accesses the media items 44 in each training data unit 2804A, 2804B, . . . 2804C in the application-specific training data set 2804. This may require decrypting the media items based on a decryption key obtained from the information in the encryption information block 46 of each training data unit 2804A, 2804B, . . . 2804C.

At step 145, the rights issuer module 120 generates the use rights associated with the training data package (as a whole, denoted 2800) such that the use of the training data package 2800 to train an AI platform can be managed. The use rights are place in a use rights data block 2848 (or field) of the training data package 2800.

In a specific example of implementation, the rights issuer module 120 will generate the use rights for the entire training data package 2800 on the basis of the use rights of the individual training data units 2804A, 2804B, . . . 2804C it contains. It is conceivable that the application-specific training data set 2804 will hold training data units 2804A, 2804B, . . . 2804C that are owned by different entities and be associated with different use rights. Accordingly, the generation of the use rights for the training data package 2800 necessitates consideration of the individual use rights. Two possibilities exist:
a. The use rights in every training data unit 2804A, 2804B, . . . 2804C in the application-specific training data set 2804 are identical. In such instance, the same use rights are replicated for the training data package 2800. That is to say, the training data package 2800 will inherit the same use rights (in respect of licensed applications of the AI platform, licensed regions and licensed AI platforms) as any individual training data unit 2804A, 2804B, . . . 2804C in the application-specific training data set 2804.
b. The use rights in the training data units 2804A, 2804B, . . . 2804C of the application-specific training data set 2804 are not identical. While the use rights under each training data unit 2804A, 2804B, . . . 2804C are compliant with the environmental perception system specification as specified by the user, the use rights may not be the same across training data units 2804A, 2804B, . . . 2804C. For example, training data unit 2804A may have use rights that specifies licensed applications for the AI platform for terrestrial and aerial use, while training data unit 2804B may allow only for terrestrial use. In such case, the aerial use license is stripped away and only the terrestrial license is carried over into the training data package 2800. In such fashion, the collective use rights under the training data package 2800 remain consistent with the environmental perception system specifications. In this example, the use rights (in respect of, e.g., licensed applications of the AI platform, licensed regions and licensed AI platforms) for the entire training data package 2800 are those that are common to each individual training data unit.

At step 146, a metadata information data block 2850 (or field) for the training data package 2800 is generated. In a specific example of implementation, the metadata for the training data package 2800 is a combination or union of the metadata for the individual training data units 2804A, 2804B, . . . 2804C. For example, the metadata for the training data package 2800 would list all the objects that appear in the media items of the training data package. As an option, the metadata for the training data package 2800 may also provide statistical information on the overall training data package 2800, such as the total number of objects, relative distribution between objects (20% bicycles, 40% cars, 18% pedestrians), total number of media items in the package, etc. More specifically, the rights issuer module 120 extracts the metadata from the metadata block 50 of every training data unit 2804A, 2804B, . . . 2804C in the application-specific data set 2804, performs a statistical analysis and stores the results in the metadata information block 2850 of the training data package 2800.

At step 147, the rights issuer module 120 generates the unique identifier for the training data package 2800 and places it in a unique identifier data block 2852 (or field). Optionally, at step 148, the rights issuer module 120 can generate an encryption information block 2846 (which identifies a key stored in the encryption key database 110), and finally at step 149, portions of the training data package 2800 are encrypted.

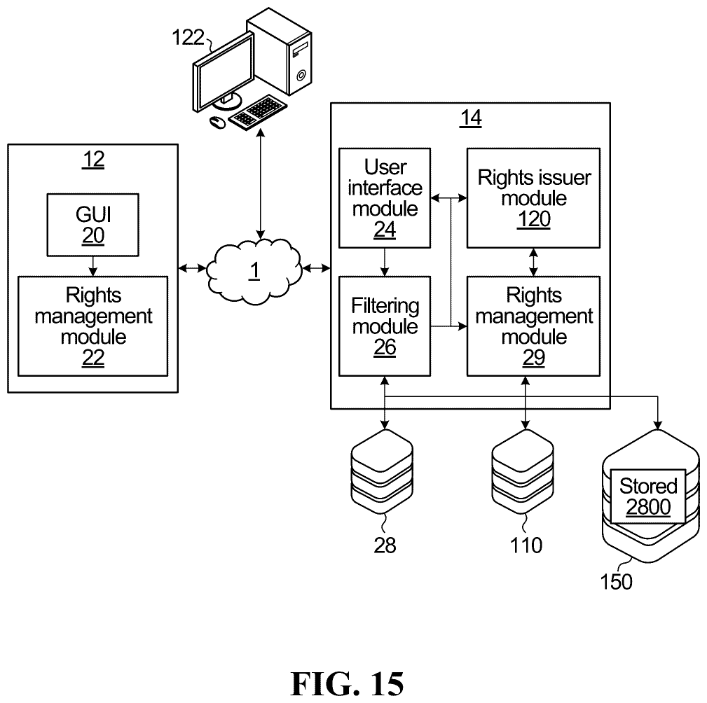

Once the training data package 2800 is finalized, it is stored in a training data package database 150 as shown in FIG. 15, which is a variant of FIG. 12.

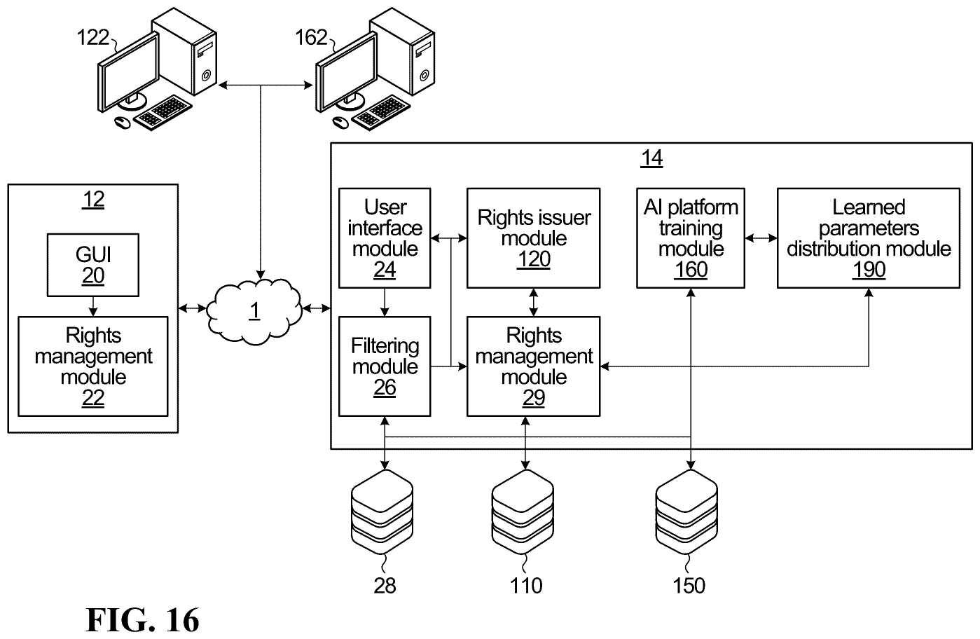

FIG. 16, which is a variant of FIG. 15, illustrates another example of implementation of the management server 14, which includes a functionality for using a training data package (such as the training database package 2800) that is stored in the training data package database 150, in order to perform the training of an AI platform 162. More specifically, the management server 14 includes an AI platform training module 160, which receives the training data package from the training data package database 150 and performs the training process on the basis of the media content in the training data package. In addition to the training data package, the AI platform training module 160 also receives a model of the AI platform 162 to train. The output of the AI platform training module 160 is a set of learned AI parameters of the AI platform 162 which are generated as a result of the training of the model with the training data. An example of learnable parameters is weights and biases. Specific weight and biases values generated by the training process are the learned parameters of the AI platform 162. For more information on AI platforms and systems, reference may be had to Artificial Intelligence: Fundamentals and Applications, Cherry Bhargava and Pradeep Kumar Sharma (Eds.), ISBN 9780367559700, Published Jul. 29, 2021 by CRC Press, hereby incorporated by reference herein.

Before the AI platform training module 160 can access the training data package and use it to perform the training operation, the training data package may have to be decrypted and such decryption is subject to compliance verification with the use rights attached to the training data package.

Consider the scenario where a user at workstation 12 communicates with the management server 14 to control training operation by the AI platform training module 160. As in the previous examples of interaction with the management server 14, the user works through a GUI that is implemented by the user interface module 24. The user at workstation 12 provides inputs to allow the rights management module 29 to determine if the use of the training data package 2800 is compliant with the use rights associated with the training data package. For instance, the user specifies via the GUI the intended application for the AI platform 162 to be trained, the intended region in which the AI platform 162 will be used and provides the AI platform identifier. In turn, the rights management module 29 compares the specifications of the intended use provided by user via the GUI with the use rights in the use rights block 2848 of the training data package 2800 and if they match, the AI platform training module 160 may proceed to perform the training operation.

In a variant, the AI platform model on which the training is being performed is encoded with a platform ID, which can be directly read by the rights management module 29, thus obviating the need for the user at the workstation 12 to supply this information.

Therefore, what is provided is a method of operating a computer to build a customized training dataset for training an artificial intelligence (AI) platform. This method includes obtaining (i) specifications of training data for training the AI platform and (ii) data indicative of a proposed usage of the training data; consulting a database of training datasets, each associated with use rights, to identify a candidate set of training datasets matching the specifications; and authorizing release of a subset of the training datasets in the candidate set of training datasets based on the data indicative of the proposed usage of the AI training data and the use rights associated with the training data sets in the candidate set of training datasets.

In some embodiments, the specifications include an application scope and the application scope includes at least one of (i) a global application; and (ii) a specific application; the specifications may further include a list of objects. The specifications may also include a minimum percentage of training data derived from real-world imaging or a maximum percentage of training data derived synthetically.

In some embodiments, the data indicative of a proposed usage of the training data includes one or more of (i) an identifier of the AI platform and (ii) a proposed geographic region.

In some embodiments, the method further comprises implementing a graphical user interface for obtaining the specifications and the data are obtained from a user.

In some embodiments, the authorizing comprises creating a subset of the candidate set of training datasets, the subset including those training datasets in the candidate set for which the use rights include the proposed usage of the AI training data.

In some embodiments, the subset of the candidate set of training datasets excludes any training datasets in the candidate set for which the use rights do not include the proposed usage of the AI training data.

In some embodiments, the specifications and the data indicative of a proposed usage of the training data are obtained from a user, the method further comprising determining whether the user has a license to train the AI platform.

In some embodiments, at least some of the training datasets in the database are encrypted and wherein if the user is determined to have a license to train the AI platform, the consulting comprises a step of decrypting the at least some of the training datasets in the database.

In some embodiments, the training datasets each have a common format comprising a plurality of data blocks, wherein the plurality of data blocks includes a first data block containing training media for the respective training dataset, a second data block indicative of the use rights for the respective training dataset, a third data block indicative of media metadata corresponding to the training media in the first data block and optionally a fourth data block indicative of a unique user identifier for the respective training dataset.

In some embodiments, the plurality of data blocks further includes fifth data block indicative of encryption information related to the first data block.

In some embodiments, the media metadata corresponding to the training media in the first data block comprises a list of objects depicted in the training media.

In some embodiments, the media metadata corresponding to the training media in the first data block is further indicative of whether the training media was derived from real-world imaging or derived synthetically.

In some embodiments, the media metadata corresponding to the training media in the first data block further comprises annotations.

In some embodiments, to identify a candidate set of training datasets matching the specifications, the method comprises comparing the specifications to the media metadata in the third data block of each of the training datasets, the candidate set of training datasets including those training datasets for which the media metadata in the third data block of the respective training datasets matches the specifications.

In some embodiments, the specifications comprise a user-provided application scope, whereas in other embodiments, the specifications comprise a user-provided list of objects. The specifications may also comprise a user-specified application scope, wherein the use rights in the second data block comprise information related to a licensed application scope for the respective training dataset, wherein to identify a candidate set of training datasets matching the specifications, the method comprises comparing the user-specified application scope to the licensed application scope, the candidate set of training datasets including those training datasets for which the licensed application scope in the second data block of the respective training dataset includes the user-specified application scope.

In some embodiments, the specifications comprise a user-specified list of objects, wherein the media metadata corresponding to the training media in the first data block comprises information related to a list of objects depicted in the training media in the first data block, wherein to identify a candidate set of training datasets matching the specifications, the method further comprises comparing the user-specified list of objects to the list of objects in the third data block of each of the training datasets, the candidate set of training datasets excluding those training datasets for which the list of objects in the third data block of the respective training dataset does not contain any of the objects in the user-specified list of objects.

In some embodiments, the authorizing comprises creating the subset of the candidate set of training datasets, the subset including those training datasets in the candidate set for which the use rights in the second data block of the respective training datasets include the proposed usage of the AI training data.

In some embodiments, the proposed usage of the AI training data comprises an identifier of the AI platform, wherein the use rights in the second data block of each of the training datasets identifies at least one licensed AI platform, wherein the authorizing comprises creating the subset of the candidate set of training datasets, the subset including those training datasets in the candidate set for which the at least one licensed AI platform identified by the second data block of the respective training dataset includes the identifier of the AI platform.

In some embodiments, the proposed usage of the AI training data comprises a proposed geographic region, wherein the use rights in the second data block of each of the training datasets further comprises a licensed geographic region, wherein the authorizing comprises creating the subset of the candidate set of training datasets, the subset including those training datasets in the candidate set for which the licensed geographic region in the second data block of the respective training dataset includes the proposed geographic region.

In some embodiments, the method further comprises determining use rights for the subset of training datasets, and storing the determined use rights in the database in association with the subset of training datasets.

In some embodiments, the method further comprises setting the use rights for the subset of training datasets based on the use rights associated with each of the training datasets in the subset of training datasets.

In some embodiments, when the use rights associated with each of the training datasets in the subset of training datasets are identical, the use rights for the subset of training datasets are set to the identical use rights associated with each of the training datasets in the subset of training datasets.

In some embodiments, when the use rights associated with each of the training datasets in the subset of training datasets are not identical, the use rights for the subset of training datasets are set to those use rights that are common to each of the training datasets in the subset of training datasets.

In some embodiments, the training datasets each have a common format comprising a plurality of data blocks, wherein the plurality of data blocks includes a first data block containing training media for the respective training dataset, a second data block indicative of the use rights for the respective training dataset, a third data block indicative of media metadata corresponding to the training media in the first data block and optionally a fourth data block indicative of a unique user identifier for the respective training dataset, the method further comprising grouping the subset of training datasets into a training dataset package and storing the training dataset package in a non-transitory medium.

In some embodiments, the method further comprises providing the training dataset package with a use rights field that is populated based on the use rights stored in the second data block of the training datasets in the subset of training datasets.

In some embodiments, the contents of the use rights field of the training dataset package is an intersection of the use rights stored in the second data block of the training datasets in the subset of training datasets.

In some embodiments, the method further comprises providing the training dataset package with a metadata field that is populated based on the metadata stored in the third data block of the training datasets in the subset of training datasets.

In some embodiments, the contents of the metadata field of the training dataset package is a union of the metadata stored in the third data block of the training datasets in the subset of training datasets.

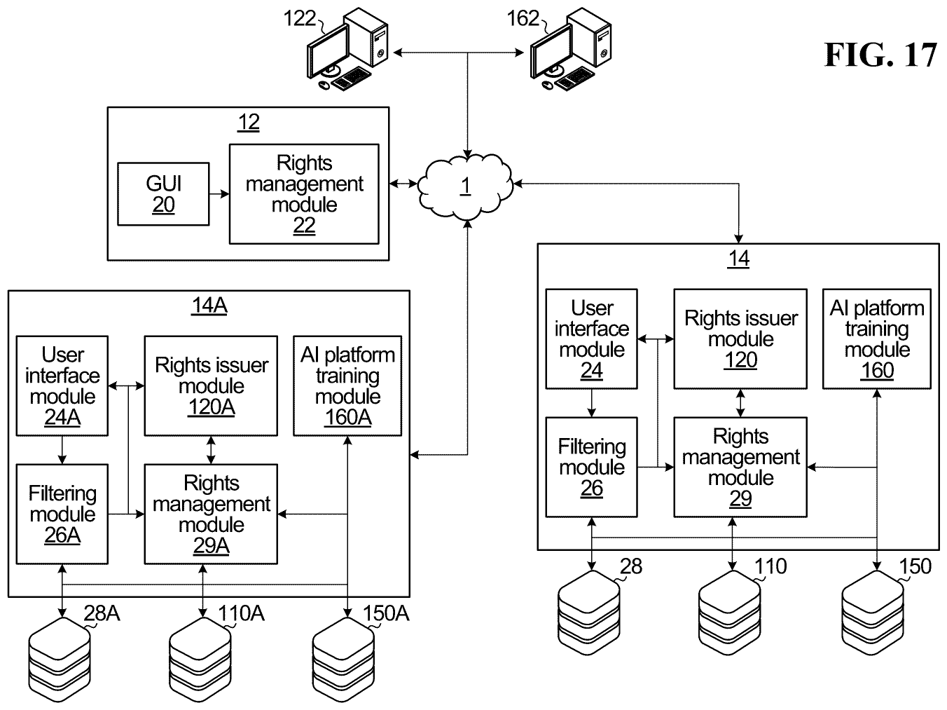

FIG. 17 illustrates yet another variant where the training of the AI platform 162 is performed at a remote location from the management server 14. FIG. 17 illustrates a scenario where training needs to be performed in a specified location to comply with certain requirements, such as government regulations that govern the use of training data and/or the use of the learned parameters generated from the training data. For example, such regulations may stipulate that training data collected in a certain region or country cannot be exported or otherwise used outside that country or region. Accordingly, to comply with such regulations, it is necessary to store the training data in the region and country and process the training data to perform the AI training in such country or region. Yet, the training of the AI platform 162 may require use of additional training data, which resides outside the region or country. The system of FIG. 17 is configured to allow transfer of training data which is not subject to storage and/or use restrictions to a remote site to augment the local training data that is subject to storage and/or use restrictions, in order to provide an effective training data set for training an AI platform.

More specifically, the system includes a second management server 14A which resides in the country or region that imposes the restrictions on the training data and/or the learned parameters, which is similar in structure and functionality to the management server 14. Specifically, the management server 14A has a user interface module 24A (similar to the user interface module 24), a rights issuer module 120A (similar to the rights issuer module 120), a filtering module 26A (similar to the filtering module 26), a rights management module 29A (similar to the rights management module 29) and an AI platform training module 160A (similar to the AI platform training module 160). In addition, the management server 14A communicates with a training data collection stored in a database 28A (similar to the database 28), an encryption key database 110A (similar to the encryption key database 110) and a training data package database 150A (similar to the training data package database 150).

Operation of the management server 14A is similar to operation of the management server 14, in that the management server 14A can receive inputs from a workstation (such as the workstation 12) to define the specifications of an environmental perception system, run a query via the filtering module 26A to generate a customized training data set, generate a corresponding training data package and use that training data package to perform AI platform training.

The filtering module 26A is configured such that it has visibility over both databases 28 and 28A. Accordingly, when the filtering module 26A runs a query, it can flag training data units in either or both databases 28, 28A as being relevant. Such remote visibility is possible if the training data units stored in database 28 have no restrictions attached to them, and allows an external entity, which can be an entity residing outside the region or country, to read the metadata associated with such training data units. The reciprocal approach is also possible, namely allowing the filtering module 26 to have visibility on the training data stored in database 28A, on the assumption the regulations that govern the use and or storage of the training data units in the database 28A would allow access to the corresponding metadata.

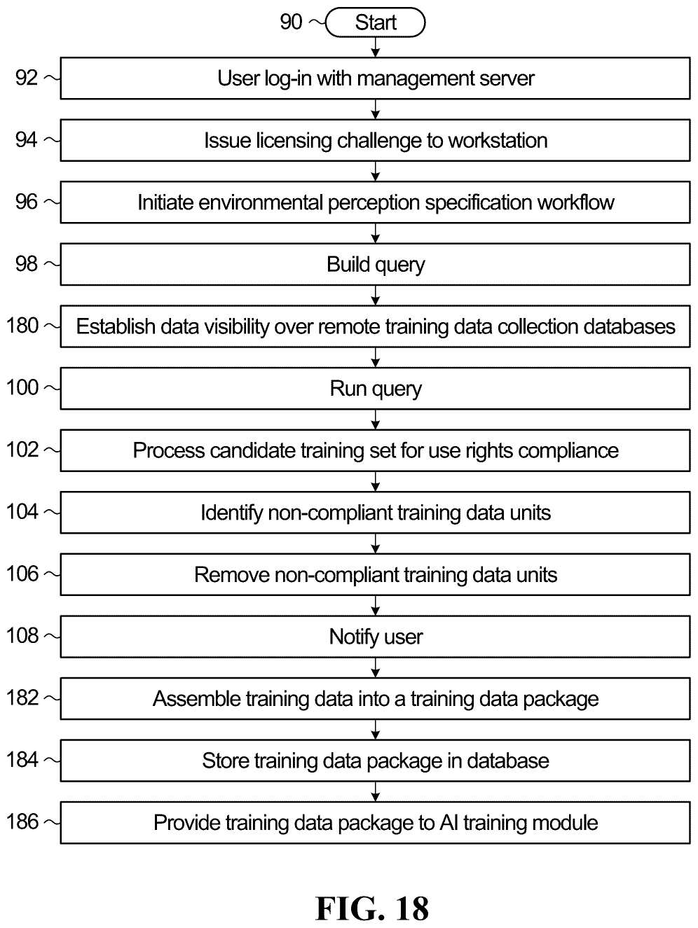

The process for building a training data package at the management server 14A is depicted by the flowchart of FIG. 18, which is a variant of the flowchart of FIG. 9 that describes extracting an application-specific training data set by the management server 14. Steps that are analogous to both flowcharts are designated with the same reference numerals.

At step 92, the operator at the workstation 12 (which in this case communicates with the management server 14A) logs in with suitable credentials, such as a username and password, among others.

At step 94, the rights management module 29A issues a licensing challenge to the workstation 12 to determine what license has been granted to the workstation/user and makes available to the workstation/user the services that are consistent with the scope of the license. Note that in this implementation, the rights management module 29A that handles license verifications is implemented at the management server 14A. In a possible variant, the license verification operation can be performed by the rights management module 29 of the management server 14. In other words, the rights management module that carries out step 94 can be a central license manager tool that services a variety of remote management servers and handles license verification services for all transactions on the remote management servers.

At step 96, the management server 14A initiates the environmental perception specification workflow as described earlier, where the user will enter the specifications of the environmental perception system.

At step 98, a query is built.

At step 180 a process is run to establish data visibility over all remote training data collection databases (in this case, databases 28, 28A). The objective of this part of the process is to establish, at the management server 14A, a global list of all the training data units stored in remote databases, such that a query can be run in the global list to identify, in the entire training data collection that is stored across multiple databases, the relevant training data units that meet the query parameters. Practically, but not necessarily, this can be performed by storing at each training data collection database 28, 28A a global list of the training data units in the entire collection, where each entry in the list corresponds to a training data unit and includes the metadata and optionally other information blocks, but omits the media units, such that the query can be run, as shown at step 100.

Steps 102, 104 and 106 are then performed against the entries in the global list, which produces a final set of training data units that meet the parameters of the query. Assuming for the sake of this example that 80% of the training data units so selected reside at the database 28A and 20% reside at the (remote) database 28. In order to access the media units of the training data units that are locally stored at the database 28A, the rights management module 29A will perform the necessary license verification, as described earlier, and fetch the decryption key from the encryption key database 110A. The decryption key can then be used to decrypt the media items in the training data units stored in the local database 28A. As to the data training units that are stored in the remote database 28, a similar operation is performed but this time it involves the rights management module 29 at the management server 14. More specifically, a request is channeled via the data network 1 from the management server 14A to the management server 14 to request the media units and the decryption key in relation to a specific number of training data units that are stored in the database 28. The rights management module 29 will perform the validation operation to determine if the intended use is in compliance with the license (a.g., in particular, to determine whether the license allows export of the training data to a different site) and, in the affirmative, the training data units are extracted from the database 28 and the decryption key is fetched from the encryption key database 110, and are both relayed back to the management server 14A and in particular to the rights management module 29A such that the media of the 20% of the training data units can now be decrypted.

It will be noted that the above-described arrangement allows using training data which is stored in a distributed fashion at sites which are subject to a range of different laws/regulations. An advantage of the system is that it provides an efficient and flexible mechanism to manage the use of the training data such as to maintain compliance with the laws/regulations. For example, training data which is subject to an export ban will be blocked from being sent to a remote site since the use rights associated with the training data authorizes only local use, hence the rights management module will block the data export and will not provide the decryption key to the remote site. However, for training data that is exportable to the remote site, where the use rights associated with the training data authorize the use of the training data at the remote site, the rights management module 29A will transfer the data and provide the decryption key such that the media can be used at the remote site.

At step 182, the decrypted training data is assembled into a training data package, stored in the training data package database 150A at step 184 and provided to the AI training module 160A for performing a training operation at step 186.

The AI platform training modules 160 and 160A include high speed data processors, such as high-performance Graphics Processing Units to process the media in the training data package and generate learned parameters for the AI platform. In a specific example, the learned parameters are weights and biases of a neural network. The learned parameters can then be loaded in AI platforms and used to perform environmental perception. For example, the learned parameters can be loaded in an AI platform implemented in a vehicle such as to provide environmental perception, which in turn is used for autonomous or semi-autonomous operation of the vehicle.

In a specific example, the learned parameters are generated at a certain site, and they are loaded in individual AI platforms of a fleet, which may include several hundreds or even thousands of units. As indicated previously, the AI platforms would typically be vehicles, but they can be implemented in any kind of automated equipment that requires environmental perception to provide an autonomous functionality, which can include terrestrial, aerial and marine vehicles, for a variety of applications including agricultural, mining, industrial, commercial delivery and people transport.

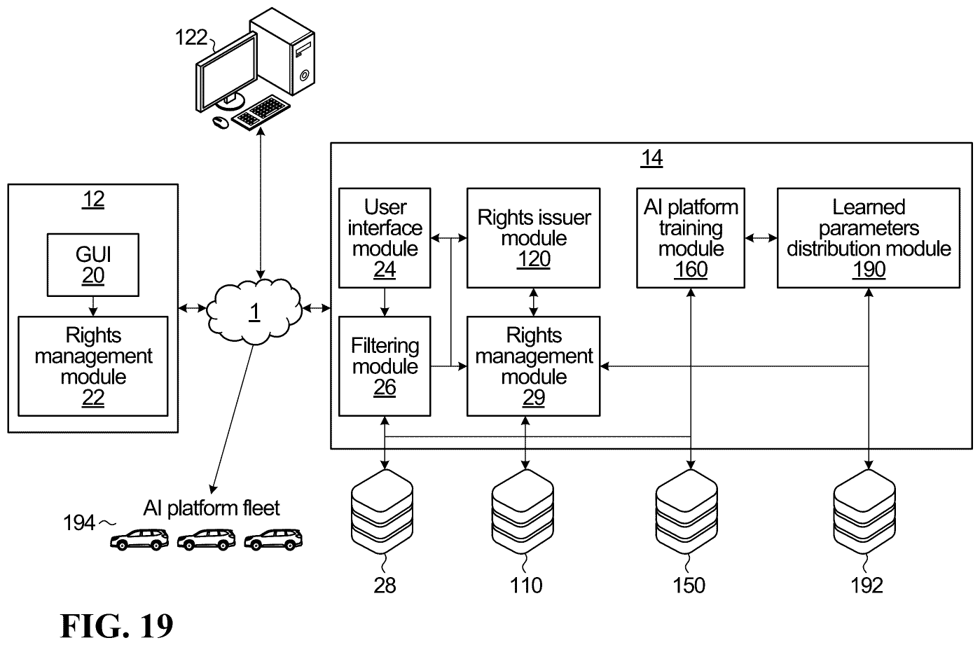

FIG. 19 is a block diagram, which is a variant of FIG. 16, including a module 190 for performing the distribution of learned parameters to a plurality of AI platforms. In a specific example of implementation, the AI platforms can be vehicles. The distribution can include an initial loading of the learned parameters in an AI platform. That is to say, the AI platform is initially functionless in the sense that it is not yet programed to perform environmental perception. That would be typically the case when the vehicle is being manufactured and the hardware that implements the AI platform is being installed in the vehicle. The initial loading of the learned parameters, which can be performed at the production line, would provide the AI platform with an environmental perception functionality such as to enable autonomous or semi-autonomous functionalities.

The distribution of learned parameters by the system of FIG. 19 can also performed in the context of updates. In other words, the existing learned parameters in the AI platform are replaced by new learned parameters to provide a different or an enhanced environmental perception functionality.

The learned parameters distribution module 190 communicates with the AI platform training module 160 and receives from the AI training module 160 learned parameters generated as a result of the training operation. Also, the learned parameters distribution module 190 communicates with the rights management module 29 and with the rights issuer module 120 such as to create a learned parameters package associated with use rights in order to be able to manage the use of the learned parameters in the AI platforms.

An AI platform fleet is generically shown in FIG. 19 at 194. The fleet has a number of individual AI platforms that can receive the learned parameters package via an Over The Air (OTA) update or via any other suitable communication method. For instance, each AI platform can be provided with communication capabilities via a data network 1, such as the Internet, and communicate with the management server 14 periodically, to receive the learned parameters package and then install the learned parameters package to enable the AI platform to perform environmental perception.

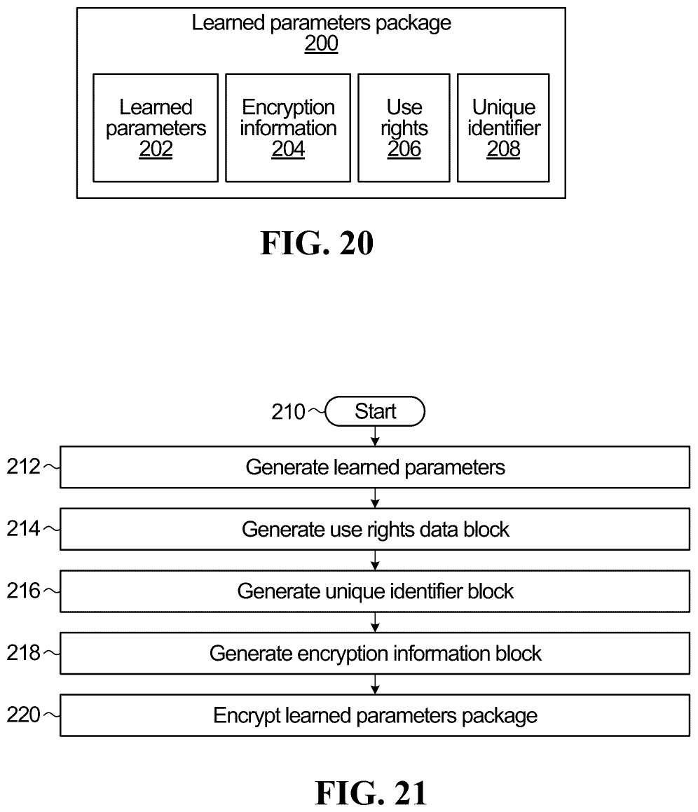

FIG. 20 is a diagram illustrating the general data structure of the learned parameters package 200. It will be noted that the data structure of the learned parameters package 200 has a structure that is similar to the structure of a training data unit 400. In particular, the learned parameters package 200 includes a learned parameters data block 202, an encryption information data block 204, use rights data block 206 and a unique identifier data block 208.

The learned parameters data block 202 holds the weights and biases that the AI platform would use to provide environmental perception. The encryption information block 204 holds encryption information, the use rights data block 206 stores information about the permitted use of the learned parameters and the unique identifier 208 uniquely identifies this learned parameters package 200 among other packages.

The flowchart in FIG. 21 provides an example of a process for generating the learned parameters package 200.

The process starts at 210. At step 212, the AI platform training module 160 performs the training process and generates the learned parameters. At step 214, the rights issuer module 120 generates the use rights data block 206 that will determine the permitted use of the learned parameters. In a specific example of implementation, the use rights for the learned parameters package 200 are derived fully or in part from the use rights associated with the training data upstream, that is, the training data package 2800 and/or the training data units 40. In a specific example, the use rights associated with the learned parameters package are inherited from the use rights associated with the training data package, which in turn are inherited at least in part from the use rights associated with the individual training data units. In a specific example, assuming the training data package has use rights, including the following:
a. Licensed applications limited to terrestrial use,
b. Licensed regions limited to Canada and the US,
c. Licensed AI platforms limited to Alpha and Delta.

The rights issuer module 120 replicates the same use rights into the use rights data block 206. The rights issuer module 120 then generates the unique identifier at step 216, the encryption data block at step 218 and finally encrypts the learned parameters package at step 220.

In a variant, a user (operator) is provided with the possibility to alter the use rights for the learned parameters package in order to change those rights and adapt them to certain circumstances, via a user interface. The user interface is a Graphical User Interface providing a range of controls which display information to the user and allow the user to input information to change the default use rights or specify certain parameters of the use rights.

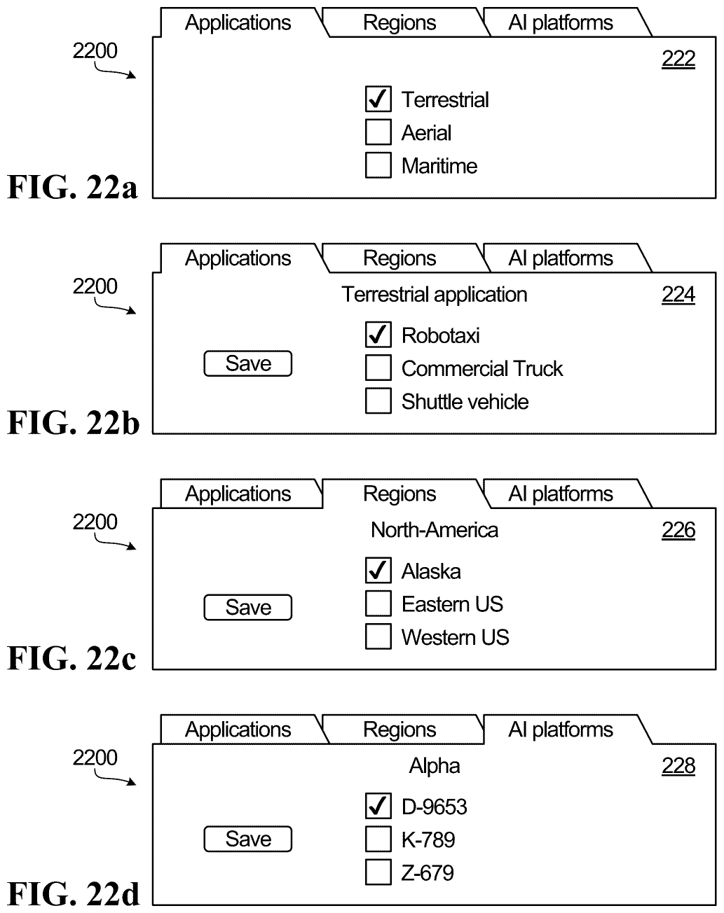

FIG. 22a is an example of such GUI 2200 that allows the user to see the default use rights for the learned parameters package 200, which may be inherited from the use rights of the training data package, and also provides the user with the possibility to make changes to these use rights. In this example, the GUI 2200 has a series of tabs that correspond to the use rights categories in order to present the information to the user in a way which is logical and easy to understand. There is an “Applications” tab, a “Regions” tab and an “AI platforms” tab. It will be understood, however, that other ways to organize the information can be used without departing from the spirit of the invention.

The Applications tab 222 shows the three main categories of applications, identifying the one inherited from the training data package. Since this is a main category of use rights, the Applications use rights may not be user selectable and the tab 222 may be provided only to inform the user of the Applications use rights that would apply. That is to say, the GUI is configured such that user inputs to change the selection from “Terrestrial” to another selection, such as Aerial or Maritime, are not accepted by the GUI.

In a variant shown in FIG. 22b, the Applications tab 222 can be used to define the licensed Applications with a finer granularity, under a particular category, which is fixed and not selectable. For example, for a licensed Terrestrial application use, the tab 222 shows a range of sub-categories which are selectable by the user. In this fashion, when global use rights have been inherited in relation to a particular category, the user can restrict the scope of the downstream rights to specific sub-categories. In this example, the global Terrestrial application category has three sub-categories, namely (1) robotaxi, (2) commercial truck and (3) shuttle vehicle. The selection mechanism is enabled on the tab 224, and the user can select a single sub-category or multiple sub-categories and then “Save” the selection(s).

With reference to FIG. 22c, the “Regions” category on tab 226 has been selected by the user, showing a number of sub-regions in the global “North-America” region. The sub-categories that are offered to the user include, “Alaska”, “Eastern US” and “Western US”, among many other possibilities. The user can select among the sub-categories in the “Regions” category the applicable ones and save the selection(s).

FIG. 22d shows the “AI platform” category 228 including the finer granularity controls provided to the user to select the AI platform. In this example, the inherited use right extends to the AI platform category “Alpha”, that is to say, each sub-category of the “Alpha” category is licensed to use the learned parameters package. The user is provided with a list of selectable options, each option corresponding to a particular sub-category, namely D-9653, K-789 and Z-679. The user can select one or multiple of those subcategories, where such selection operates to restrict the use rights only to the selected categories. In other words, sub-categories of the “Alpha” category that are not selected, would not be licensed to use the learned parameters package, even though the training data package has a blanket license for the “Alpha” category. The user selections at the tab 228 is then saved.

After the user has made the desired inputs at the GUI shown at FIGS. 22a to 22d, the selections are sent to the rights issuer module 120 that will build the use rights data block 206 accordingly, that is to say, it will add to the listed use rights the constraints or permissions derived from the user input.

After the learned parameters package 200 is assembled, it is stored in a learned parameters package database 192, it being understood that each learned parameters package can be associated with metadata to provide a description of the parameters of the learned parameters package. Although not shown in FIG. 20, the learned parameters package 200 may include a further data block for storing such metadata pertaining to the learned parameters package 200.

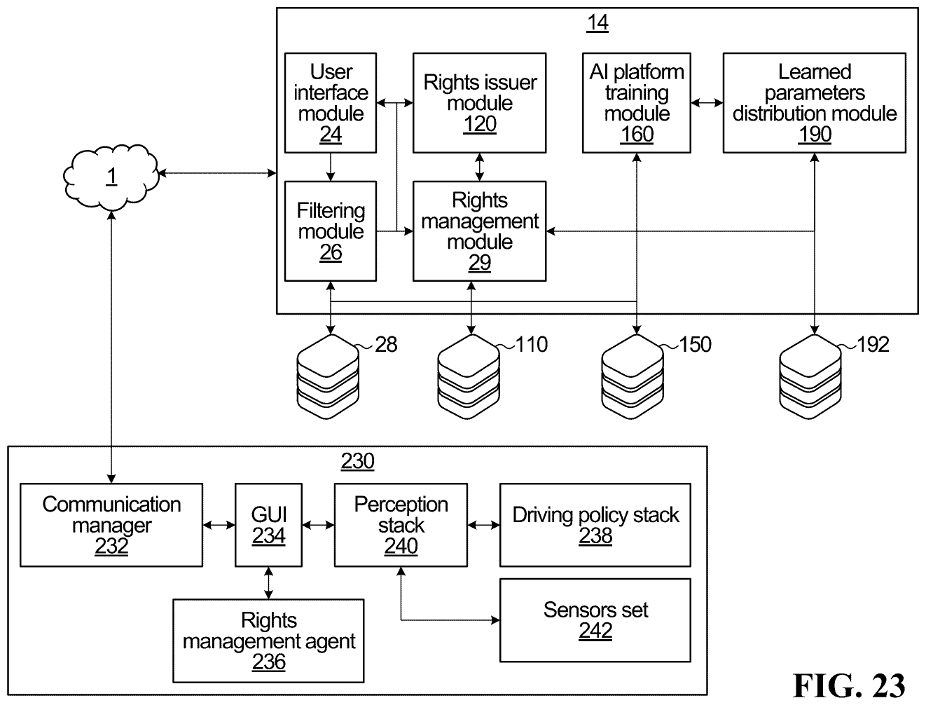

FIG. 23 illustrates a block diagram of a system for remotely updating the learned parameters of an AI platform. The system includes the management server 14 previously described and an AI platform 230, which could be integrated in a vehicle, such as a terrestrial vehicle, an aerial vehicle or a maritime vehicle. For the purposes of this example, the vehicle is a terrestrial vehicle.

The AI platform 230 includes a sensor set 242, which as indicated previously may include a range of sensors of a single modality or of different modalities. The output of the sensor set 242 is provided to a perception stack 240 which includes software that processes the sensor set output to provide environmental perception and generate a 3D map of the environment. The output of the perception stack 240 is supplied to a driving policy stack 238 that includes software for determining the vehicle movements.

The perception stack 240 uses learned parameters to perform environmental perception. The system of FIG. 23 is designed to provide remote updating of the learned parameters, either for the purpose of improving the environmental perception performance or adapting it to provide customer-selectable added features not previously included or new features not previously available.

A GUI module 234 allows a user to control the parameters of the updating process. The GUI module 234 is in communication with a communication manager 232 that includes hardware and software elements allowing the AI platform 230 to communicate with the management server 14. In a specific example of implementation, the communication manager 232 is configured to enable wireless communication with the management server 14, such as over a cellular network or the equivalent. The AI platform 230 also includes a rights management agent 236 which controls how the AI platform 230 is allowed to use the learned parameters downloaded from the management server 14. The rights management agent 236 communicates with the rights management module 29 such that the learned parameters that are downloaded from the management server 14 can be decrypted and used by the AI platform 230 if it is properly licensed for such use, as established by the rights management agent 236.

The GUI module 234 provides the user with a number of selectable options, regarding:
a. Customize the downloading process of the learned parameters. For example, the GUI module 234 includes a control allowing the user to select between enabling automatic download of updates or disabling the automatic downloading.
b. Customization of the environmental perception. The user is provided with options to adapt the environmental performance to his or her needs, such as adding optional features to a basic environmental perception functionality. In a specific example of implementation, the basic environmental perception functionality is configured to detect a minimal range of objects that the AI platform should be able to see to provide the desired level of automation. In the context of automated urban driving, the minimal range of dynamic objects may include cars, trucks, pedestrians, cyclists, traffic signs, fire hydrants and construction markers, such as construction cones, among others. Such basic range of objects enables basic automation functions such as driving in an urban environment including city streets and highways. However, the user of the AI platform may be desirous to add to such basic automation functionality additional automation features, such as the ability to provide autonomous or semi-autonomous operation in different environments. Examples of such different environments are provided below:
   i. For commercial vehicles, such as trucks, the ability to maneuver in specific surroundings or conditions. A first example would be backing up the truck to a loading dock. In order to enable automatic loading dock approach, the environmental perception system should be able to detect the loading dock itself, that is to say the learned parameters need to be configured to identify the loading dock as an object in the 3D map. A second example relates to vehicles that operate partly in an industrial environment and partly in an urban environment. The industrial environment can be quite different from the urban environment as it includes objects that are not found in the usual urban environment. Take the example of a truck that transports containers from a port to a destination in the city. While the basic range of detectable objects may suffice for the urban driving, additional object detection capability would be required to enable autonomous operation in the port environment, where unique objects need to be detected.
   ii. For personal transportation vehicles, the ability to park in a complex environment such as an underground parking garage where the vehicle needs to navigate around many obstacles, such as columns. In order to provide such automated parking function, the environmental perception software needs to be configured to detect the obstacles. Another example in the context of personal transportation vehicles, which could also be relevant for commercial vehicles, is the added function to auto-sense the overall vehicle boundaries, such as when a trailer is connected to the vehicle. In this case, the environmental perception system is configured to “see” the trailer and output the trailer as a dynamic object which can then be taken into consideration by the driving stack to compute a “free-space” parameter, which would include essentially the vehicle dimensions plus the trailer dimensions, for driving.
   iii. Region considerations, such as updating the learned parameters based on the current location of the vehicle. The updated parameters for a new region in which the vehicle is to operate may include (1) a license update to extend the use rights that previously were limited to certain region, to a new region. In such case, the learned parameters would not change but the use rights would be updated to authorize operation within the new region.

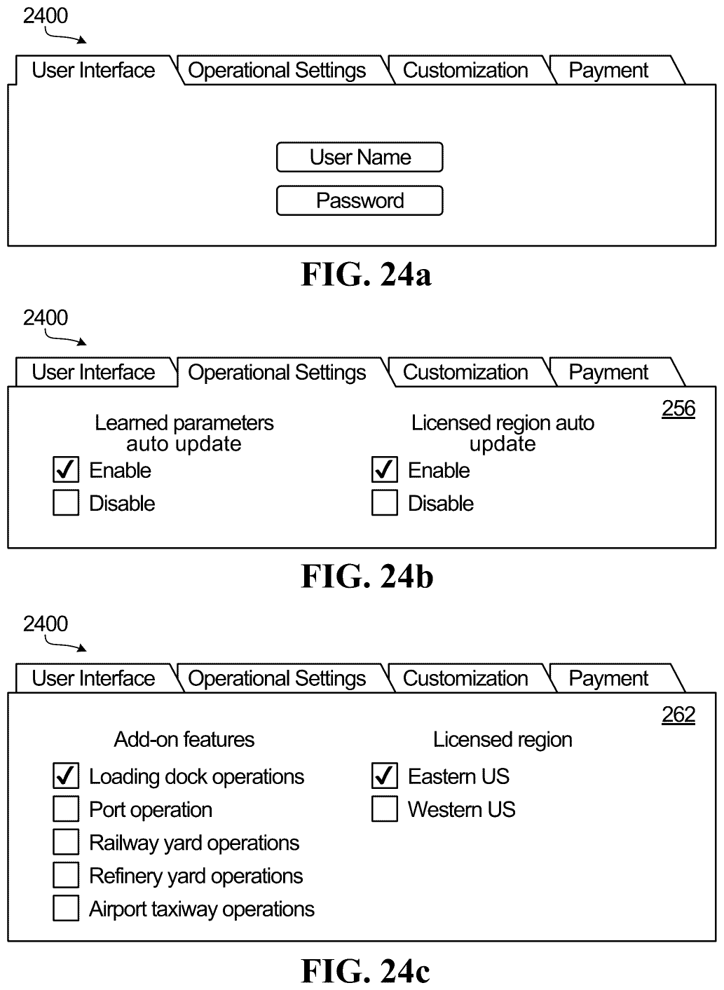

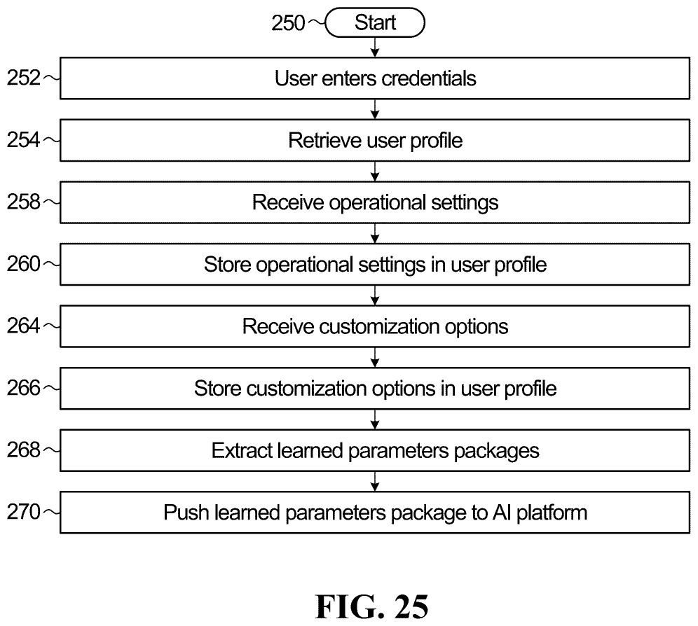

An example of a GUI implemented by the GUI module 234 is shown at FIGS. 24a, 24b and 24c that would enable the user to customize the environmental perception system. The GUI 300 has a number of screens arranged as tabs corresponding to different parameters. In this example, there are four tabs, namely (1) User Authentication, (2) Operational Settings; (3) Customization and (4) Payment. The description of the GUI 2400 will be made in conjunction with the flowchart of FIG. 25 that describes the different steps of the process for updating the learned parameters of the AI platform 230.

The process starts at 250. At step 252 the user (e.g., vehicle occupant) logs into the system by providing user credentials, such as username and password. The communication manager 232 then establishes a communication session with the management server 14, in particular with the learned parameters distribution module 190. Assuming the user authentication is successful, the learned parameters distribution module 190 retrieves the user profile at step 254 associated with this particular AI platform. The user profile stores information about the user and the AI platform that are used to adapt the selectable options at the GUI 2400, such that only options that are valid for that particular customer and also valid for the particular AI platform would show on the GUI page.

FIG. 24b shows the Operational Settings tab 256. In this example, the user is provided with two controllable settings. One of the settings is the learned parameters auto update settings, which can be enabled or disabled. The auto update settings allow the management server 14 to push auto updates over the data network 1. Such updates are typically provided to fix bugs or improve the reliability of the basic object detection. The other controllable setting is the licensed region auto update setting, which can be enabled or disabled. This setting provides the ability to push updates automatically to enable a seamless driving from one licensed region to another. When the user sets this setting to “enable” the AI platform 230 will notify the management server 14 when the vehicle is moving from one licensed region and request learned parameters and/or a license update to enable using the current parameters outside the originally licensed region. The rights management agent 236 which is responsible for usage tracking receives location information from a range of possible sources, such as the 3D map generated by the environmental perception system and triggers an auto update when determining that the vehicle is operating outside the licensed region. The auto update includes the rights management agent 236 generating a message to the management server 14 to indicate the current region in which the vehicle is travelling. In response to this message the learned parameters distribution module 190 determines what the vehicle needs in terms of learned parameters, extracts those from the database 192 and sends them to the rights management agent 236 with the decryption key so they can be decrypted and installed. In case only a license update is necessary, no new learned parameters are pushed to the AI platform 230 and only a license update is generated and sent to the rights management agent 236. In addition, a transaction event can be triggered if the license extension would require billing the user.

Referring back to FIG. 25, the settings of the operational parameters relating to the learned parameters auto update and the licensed region auto update are received at step 258 and stored in the user profile at step 260.

Referring now to FIG. 24c, the Customization tab 262 will be discussed in detail. This tab 262 provides the user with controls to allow the user to choose specific operational capabilities for the autonomous or semi-autonomous operation of the vehicle, which in turn require specific learned parameters. In terms of add-on features, the user is provided with five selectable options, it being understood that more or fewer options can be provided without departing from the spirit of the invention. The options include, Loading dock operations, Port operations, Railway yard operations, Refinery yard operations and Airport taxiway operations. The tab 262, also provides licensed region options to set the AI platform for operation in a particular region. The examples shown provide a choice between Eastern US and Western US.

As shown at the flowchart at FIG. 25, after reception of the customization options selected by the user by the learned parameters distribution module 190 at step 264, the customization options are stored in the user profile at step 266. At step 268, the learned parameters distribution module 190 retrieves the learned parameters package corresponding to the user's selections from the database 192, it being understood that the learned parameters distribution module 190 applies a filter to extract only the learned parameter packages that are compatible with and/or licensed to the AI platform. That is to say learned parameter packages that are not compatible or authorized to the be used with the AI platform will not be selected. The filtering operation is performed on the basis of the use rights block 206 in the learned parameter packages that lists the allowable AI platforms.

The retrieved learned parameters packages can then be displayed to the user via the GUI 2400, allowing the user to make a selection. Optionally, pricing information can be presented to the user, if the use of the selected learned parameters packages is subject to payment. Payment can be made via the payment tab of the GUI 2400. At step 270, following payment processing the learned parameter package is pushed to the AI platform 230, including the decryption key to enable the rights management agent 236 to decrypt the learned parameters package and provide it to the perception stack 240 for installation and then use.

Aspects of the present disclosure may be implemented with any combination of hardware and software. If implemented as a computer-implemented apparatus, such aspects may be implemented using means for performing all of the steps and functions described above. Aspects of the present disclosure can also be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

For purposes of illustration, application programs and other executable program components are illustrated herein as discrete blocks, although it is recognized that such programs and components reside at various times in different storage components of the computing system and are executed by the data processor(s) of the computer. An implementation of content control software can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and communications media. “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

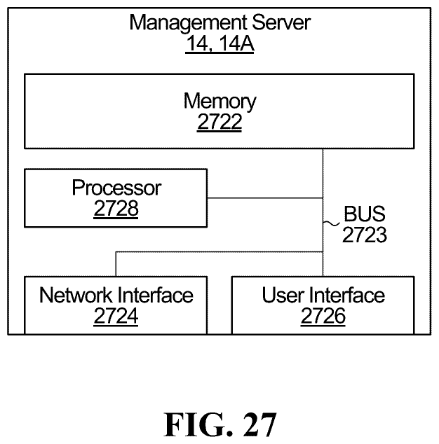

By way of non-limiting embodiment, and with reference to FIG. 27, the management server 14, 14A (and also the AI platform 230) can include a computer-readable storage medium 2722, which can be a tangible device capable of storing program instructions for use by a processor 2728. The computer-readable storage medium 2722 may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium 2722 includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, does not include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The program instructions can be downloaded to the computer-readable storage medium 2722 from an external computer or external storage device via the data network 1. A network adapter card or network interface 2724 in the management server 14, 14A receives program instructions over the data network 1 and forwards them to the computer-readable storage medium 2722 for storage and execution by the processor 2728. Execution of the program instructions by the processor 28 results in the management server 14 carrying out various processes as described above.

A user interface 2726 is also connected to the processor 2728 and may include various input and/or output devices, as well as program instructions that interact with the various input and/or output devices so as to elicit input from the user 60 and provide output to the user 60 via the input and/or output devices. The user interface 2726 may be a graphical user interface for interfacing with a user. A bus architecture 2723 may interconnect the user interface 2726, the processor 2728, the memory 2722 and the network interface 2724.

The various program instructions referred to above may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the program instructions by utilizing state information to personalize the electronic circuitry, in order to carry out aspects of the present disclosure.

Aspects of the present disclosure are described herein with reference to flowcharts and block diagrams of methods and apparatus (systems), according to various embodiments. It will be understood that each block of the flowcharts and block diagrams, and combinations of such blocks, can be implemented by execution of the program instructions. Namely, the program instructions, which are read and processed by the processor 2728 direct the processor 2728 to implement the functions/acts specified in the flowchart and/or block diagram block or blocks. Examples of such functions are those implemented by the user interface module 24, 24A, rights issuer module 120, 120A, filtering module 26, 26A, rights management module 29, 29A, AI platform training module 160, 160A, learned parameters distribution module 190, communication manager 232, GUI 234, perception stack 240, driving policy stack 238 and right management agent 236, to name a few non-limiting possibilities. It will also be noted that each block of the flowcharts and/or block diagrams, and combinations of such blocks, can also be implemented by special purpose hardware-based systems that perform the specified functions or acts or carry out combinations of special purpose hardware and computer instructions.

The flowcharts and block diagrams illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved.

The descriptions of the various embodiments of the present disclosure have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It should be appreciated that throughout the specification, discussions utilizing terms such as “processing”, “computing”, “calculating”, “determining”, “analyzing” or the like, can refer to the action and/or processes of a computer or computing system, or similar electronic computing device, that manipulate and/or transform data represented as physical, such as electronic, quantities into other data similarly represented as physical quantities.

As used herein, unless otherwise specified, the use of the ordinal adjectives “first”, “second”, “third”, etc., to describe a common object or step, merely indicate that different instances of like objects or steps are being referred to, and are not intended to imply that the objects or steps so described must be in a given sequence, either temporally, spatially, in ranking, or in any other manner.

It is noted that various individual features may be described only in the context of one embodiment. The particular choice for description herein with regard to a single embodiment is not to be taken as a limitation that the particular feature is only applicable to the embodiment in which it is described. Various features described in the context of one embodiment described herein may be equally applicable to, additive, or interchangeable with other embodiments described herein, and in various combinations, groupings or arrangements. In particular, use of a single reference numeral herein to illustrate, define, or describe a particular feature does not mean that the feature cannot be associated or equated to another feature in another drawing figure or description.

Also, when the phrase “at least one of C and D” is used, this phrase is intended to and is hereby defined as a choice of C or D or both C and D, which is similar to the phrase “and/or”. Where more than two variables are present in such a phrase, this phrase is hereby defined as including only one of the variables, any one of the variables, any combination of any of the variables, and all of the variables.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

The foregoing description and accompanying drawings illustrate the principles and modes of operation of certain embodiments. However, these embodiments should not be considered limiting. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. A method of operating a computer to build a customized training dataset for training an artificial intelligence (AI) platform, the method comprising:
obtaining (i) specifications of training data for training the AI platform and (ii) data indicative of a proposed usage of the training data;
consulting a database of training datasets, each associated with use rights, to identify a candidate set of training datasets matching the specifications; and
authorizing release of a subset of the training datasets in the candidate set of training datasets based on the data indicative of the proposed usage of the AI training data and the use rights associated with the training data sets in the candidate set of training datasets.

2. The method defined in claim 1, wherein the specifications include an application scope.

3. The method defined in claim 2, wherein the application scope includes at least one of (i) a global application; and (ii) a specific application.

4. The method defined in claim 1, wherein the specifications further include a list of objects.

5. The method defined in claim 1, wherein the specifications include a minimum percentage of training data derived from real-world imaging or a maximum percentage of training data derived synthetically.

6. The method defined in claim 1, wherein the data indicative of a proposed usage of the training data includes one or more of (i) an identifier of the AI platform and (ii) a proposed geographic region.

7. The method defined in claim 1, further comprising implementing a graphical user interface for obtaining the specifications and the data are obtained from a user.

8. The method defined in claim 1, wherein the authorizing comprises creating a subset of the candidate set of training datasets, the subset including those training datasets in the candidate set for which the use rights include the proposed usage of the AI training data.

9. The method defined in claim 8, wherein the subset of the candidate set of training datasets excludes any training datasets in the candidate set for which the use rights do not include the proposed usage of the AI training data.

10. The method defined in claim 1, wherein the specifications and the data indicative of a proposed usage of the training data are obtained from a user, the method further comprising determining whether the user has a license to train the AI platform.

11. The method defined in claim 10, wherein at least some of the training datasets in the database are encrypted and wherein if the user is determined to have a license to train the AI platform, the consulting comprises a step of decrypting the at least some of the training datasets in the database.

12. The method defined in claim 1, wherein the training datasets each have a common format comprising a plurality of data blocks, wherein the plurality of data blocks includes a first data block containing training media for the respective training dataset, a second data block indicative of the use rights for the respective training dataset, a third data block indicative of media metadata corresponding to the training media in the first data block and optionally a fourth data block indicative of a unique user identifier for the respective training dataset.

13. The method defined in claim 12, wherein the plurality of data blocks further includes fifth data block indicative of encryption information related to the first data block.

14. The method defined in claim 12, wherein the media metadata corresponding to the training media in the first data block comprises a list of objects depicted in the training media.

15. The method defined in claim 12, wherein the media metadata corresponding to the training media in the first data block is further indicative of whether the training media was derived from real-world imaging or derived synthetically.

16. The method defined in claim 12, wherein the media metadata corresponding to the training media in the first data block further comprises annotations.

17. The method defined in claim 1, wherein to identify a candidate set of training datasets matching the specifications, the method comprises comparing the specifications to the media metadata in the third data block of each of the training datasets, the candidate set of training datasets including those training datasets for which the media metadata in the third data block of the respective training datasets matches the specifications.

18. The method defined in claim 1, wherein the specifications comprise a user-provided application scope.

19. The method defined in claim 1, wherein the specifications comprise a user-provided list of objects.

20. The method defined in claim 10, wherein the specifications comprise a user-specified application scope, wherein the use rights in the second data block comprise information related to a licensed application scope for the respective training dataset, wherein to identify a candidate set of training datasets matching the specifications, the method comprises comparing the user-specified application scope to the licensed application scope, the candidate set of training datasets including those training datasets for which the licensed application scope in the second data block of the respective training dataset includes the user-specified application scope.

21. The method defined in claim 10, wherein the specifications comprise a user-specified list of objects, wherein the media metadata corresponding to the training media in the first data block comprises information related to a list of objects depicted in the training media in the first data block, wherein to identify a candidate set of training datasets matching the specifications, the method further comprises comparing the user-specified list of objects to the list of objects in the third data block of each of the training datasets, the candidate set of training datasets excluding those training datasets for which the list of objects in the third data block of the respective training dataset does not contain any of the objects in the user-specified list of objects.

22. The method defined in claim 12, wherein the authorizing comprises creating the subset of the candidate set of training datasets, the subset including those training datasets in the candidate set for which the use rights in the second data block of the respective training datasets include the proposed usage of the AI training data.

23. The method defined in claim 22, wherein the proposed usage of the AI training data comprises an identifier of the AI platform, wherein the use rights in the second data block of each of the training datasets identifies at least one licensed AI platform, wherein the authorizing comprises creating the subset of the candidate set of training datasets, the subset including those training datasets in the candidate set for which the at least one licensed AI platform identified by the second data block of the respective training dataset includes the identifier of the AI platform.

24. The method defined in claim 22, wherein the proposed usage of the AI training data comprises a proposed geographic region, wherein the use rights in the second data block of each of the training datasets further comprises a licensed geographic region, wherein the authorizing comprises creating the subset of the candidate set of training datasets, the subset including those training datasets in the candidate set for which the licensed geographic region in the second data block of the respective training dataset includes the proposed geographic region.

25. The method defined in claim 1, further comprising determining use rights for the subset of training datasets, and storing the determined use rights in the database in association with the subset of training datasets.

26. The method defined in claim 25, further comprising setting the use rights for the subset of training datasets based on the use rights associated with each of the training datasets in the subset of training datasets.

27. The method defined in claim 26, wherein when the use rights associated with each of the training datasets in the subset of training datasets are identical, the use rights for the subset of training datasets are set to the identical use rights associated with each of the training datasets in the subset of training datasets.

28. The method defined in claim 26, wherein when the use rights associated with each of the training datasets in the subset of training datasets are not identical, the use rights for the subset of training datasets are set to those use rights that are common to each of the training datasets in the subset of training datasets.

29. The method defined in claim 1, wherein the training datasets each have a common format comprising a plurality of data blocks, wherein the plurality of data blocks includes a first data block containing training media for the respective training dataset, a second data block indicative of the use rights for the respective training dataset, a third data block indicative of media metadata corresponding to the training media in the first data block and optionally a fourth data block indicative of a unique user identifier for the respective training dataset, the method further comprising grouping the subset of training datasets into a training dataset package and storing the training dataset package in a non-transitory medium.

30. The method defined in claim 29, further comprising providing the training dataset package with a use rights field that is populated based on the use rights stored in the second data block of the training datasets in the subset of training datasets.

31. The method defined in claim 30, wherein the contents of the use rights field of the training dataset package is an intersection of the use rights stored in the second data block of the training datasets in the subset of training datasets.

32. The method defined in claim 30, further comprising providing the training dataset package with a metadata field that is populated based on the metadata stored in the third data block of the training datasets in the subset of training datasets.

33. The method defined in claim 32, wherein the contents of the metadata field of the training dataset package is a union of the metadata stored in the third data block of the training datasets in the subset of training datasets.

34. A non-transitory computer-readable storage medium storing instructions which, when executed by a processing entity of a computing device, causes the computing device to carry out a method build a customized training dataset for training an artificial intelligence (AI) platform, the method comprising:
obtaining (i) specifications of training data for training the AI platform and (ii) data indicative of a proposed usage of the training data;
consulting a database of training datasets, each associated with use rights, to identify a candidate set of training datasets matching the specifications; and
authorizing release of a subset of the training datasets in the candidate set of training datasets based on the data indicative of the proposed usage of the AI training data and the use rights associated with the training data sets in the candidate set of training datasets.

35. A computer system for building a customized training dataset for training an artificial intelligence (AI) platform, the computer system comprising:
a user interface module configured for obtaining (i) specifications of training data for training the AI platform and (ii) data indicative of a proposed usage of the training data;
a filtering module configured for consulting a database of training datasets, each associated with use rights, to identify a candidate set of training datasets matching the specifications; and
a rights management module configured for authorizing release of a subset of the training datasets in the candidate set of training datasets based on the data indicative of the proposed usage of the AI training data and the use rights associated with the training data sets in the candidate set of training datasets.

36. A non-transitory computer-readable storage medium comprising instructions which, when executed by a computer, cause the computer to carry out a method that comprises:
receiving media units from a user;
creating training data units based on groups of the media units, each training data unit comprising a plurality of data blocks, wherein the plurality of data blocks for a given training data unit includes:
a first data block containing media content from a respective one of the groups of media units;
a second data block indicative of use rights for the given training data unit; and
a third data block indicative of media metadata corresponding to the media content in the first data block; and
storing the training data units in a non-transitory storage medium or outputting the training data units over a data network.

37. The computer-readable medium defined in claim 36, wherein the plurality of data blocks for the given training data unit further incudes a fourth data block indicative of a unique user identifier for the given training data unit.

38. The computer-readable medium defined in claim 36, further comprising grouping the media units into said groups of media units.

39. The computer-readable medium defined in claim 36, wherein the grouping comprises grouping the media units based on objects depicted in the media units.

40. The computer-readable medium defined in claim 36, further comprising carrying out image processing to identify objects depicted in the media units and wherein the grouping is carried out so as to group together media units that depict at least some of the same objects.

41. The method defined in claim 40, wherein the media metadata in the third data block for the given training data unit comprises information related to the objects depicted in the respective group of media units.

42. The computer-readable medium defined in claim 36, further comprising receiving a list of objects depicted in the media units and wherein the grouping is carried out so as to group together media units that depict at least some of the objects in the list.

43. The method defined in claim 36, wherein the media metadata in the third data block for the given training data unit is indicative of whether the media content of the respective group of media units was derived from real-world imaging or was derived synthetically.

44. The computer-readable medium defined in claim 36, further comprising validating an identity of the user before the receiving.

45. The computer-readable medium defined in claim 36, wherein the storing includes encrypting at least part of the training data units.

46. The computer-readable medium defined in claim 45, wherein the encrypting comprises encrypting only the first data block of each of the training data units.

47. The computer-readable medium defined in claim 45, wherein the encrypting is carried out using an encryption key stored in memory.

48. The computer-readable medium defined in claim 47, wherein, upon being stored, the media unit in the first data block of each of the training data units is decryptable by a decryption key.

49. The computer-readable medium defined in claim 48, wherein the decryption key and the encryption key are the same.

50. The computer-readable medium defined in claim 48, wherein the decryption key is uniquely associated with but different from the encryption key.

51. The method defined in claim 36, wherein the plurality of data blocks further includes fifth data block indicative of how to determine the decryption key.

52. The method defined in claim 36, wherein the use rights for the given training data unit include an indication of a licensed application scope for the given training data unit.

53. The method defined in claim 36, wherein the use rights for the given training data unit include an indication of a licensed geographic region for the given training data unit.

54. The method defined in claim 36, wherein the use rights for the given training data unit include an indication of a licensed AI platform for the given training data unit.

55. The method defined in claim 36, further comprising determining the use rights for the given training data unit and storing the use rights in the second data block for the given training data unit.

56. The method defined in claim 36, wherein the media units comprise 2D camera images.

57. The method defined in claim 36, wherein the media units comprise LiDAR or RADAR data.

58. The method defined in claim 36, wherein the media units comprise an ultrasonic depth map.

59. A method of operating a computer, the method comprising:
receiving media units from a user;
creating training data units based on groups of the media units, each training data unit comprising a plurality of data blocks, wherein the plurality of data blocks for a given training data unit includes:
a first data block containing media content from a respective one of the groups of media units;
a second data block indicative of use rights for the given training data unit; and
a third data block indicative of media metadata corresponding to the media content in the first data block;
storing the training data units in a non-transitory storage medium or outputting the training data units over a data network.
